(19) United States
(12) Patent Application Publication
(10) Pub. No.: US 2003/0237098 A1
(43) Pub. Date: Dec. 25, 2003

(54) Data broadcast program control system

(76) Inventors: Koichiro Yamaguchi, Ashiya-shi (JP); Toshiya Mori, Settu-shi (JP); Hideki Kagemoto, Nara-shi (JP)

Correspondence Address: SNELL & WILMER LLP, 1920 MAIN STREET, SUITE 1200, IRVINE, CA, 92614-7230, US

(21) Appl. No.: 10/399,647

(22) PCT Filed: Jul. 9, 2002
(86) PCT No.: PCT/JP02/06942

(30) Foreign Application Priority Data
Jul. 9, 2001 (JP) 2001-207485
Oct. 23, 2001 (JP) 2001-324747
Feb. 7, 2002 (JP) 2002-30536

(51) Int. Cl. H04N 7/173; H04N 7/16; H04N 5/38

(52) U.S. Cl. 725/117; 725/91; 725/115; 725/145; 725/147; 348/723

(57) ABSTRACT

A data broadcast program control system is made up of a transmission apparatus for repeatedly transmitting a plurality of data elements that constitute a data broadcast program, and a broadcast apparatus for receiving and broadcasting the plurality of data elements. The transmission apparatus generates control information for instructing the broadcast apparatus to perform change processing on the constitution of the data broadcast program, and transmits the control information to the broadcast apparatus. The broadcast apparatus receives the control information, and performs the change processing on the constitution of the data broadcast program according to the control information. The broadcast apparatus broadcasts the data broadcast program whose constitution has been changed.

### TECHNICAL FIELD

The present invention relates to a data broadcast transmission/reception system, and in particular relates to a broadcast control system for data broadcast programs.

### BACKGROUND ART

In today's analog terrestrial broadcasting, a key station produces a broadcast program and transmits it to each local station via network lines. Each local station receives the broadcast program, and broadcasts it to viewers residing in a geographical area covered by the local station (such viewers are hereafter called “local viewers”).

In addition to broadcasting the broadcast program received from the key station directly to reception apparatuses of the local viewers, each local station also broadcasts its own broadcast program by partly changing the key station-originated broadcast program. For example, a local station replaces part of the key station-originated advertisements (hereafter referred to as “commercials”) which are aired during the live broadcast of a sports event, with a local commercial.

This replacement is performed when the local station receives a signal indicating a timing of replacement (hereafter a “NETQ signal”) from the key station at a specific time. In more detail, upon detecting the NETQ signal, the local station switches the broadcast of the key station-originated broadcast program to the broadcast of the local commercial, according to the local station's broadcast schedule which has been set beforehand. After a predetermined time period has passed, the local station ends the broadcast of the local commercial and switches back to the broadcast of the key station-originated broadcast program.

This enables a broadcaster to select local commercials which fit the needs of local viewers beforehand, and broadcast them during broadcast of a popular national program originated from the key station. Hence the advertising effects of commercials can be enhanced.

In recent years, digital broadcast services have become available. BS (Broadcasting Satellite) digital broadcasting that uses broadcast satellites has already been launched, and digital terrestrial broadcasting will soon be launched too. Digital broadcasting differs from analog broadcasting in that not only video broadcasts but also data broadcasts such as still picture and text information can be broadcast. In data broadcasting, various broadcast programs including commercials, news, weather, and games can be broadcast independently of or together with video broadcasts. Accordingly, through the effective use of data broadcasting, the broadcaster can further enhance the advertising effects of commercials intended for local viewers.

However, data broadcasting uses a different broadcasting standard and data structure of broadcast materials, from conventional analog video broadcasting. Therefore, it is impossible to simply apply the aforementioned method of replacing broadcast programs using NETQ signals, to data broadcast programs which are broadcast by data broadcasting.

### DISCLOSURE OF INVENTION

The present invention has an object of providing a data broadcast program control system for changing data broadcast programming of a key station to data broadcast programming of a local station that is intended for local viewers, under control of the key station.

The stated object can be achieved by a data broadcast program control system including a transmission apparatus that repeatedly transmits a plurality of data elements which constitute a data broadcast program, and a broadcast apparatus that receives and broadcasts the plurality of data elements, wherein the transmission apparatus includes: a control information generating unit for generating control information, the control information instructing the broadcast apparatus to perform change processing on a constitution of the data broadcast program; and a transmitting unit for transmitting the control information to the broadcast apparatus, and the broadcast apparatus includes: a receiving unit for receiving the control information; a changing unit for performing the change processing on the constitution of the data broadcast program according to the control information; and a broadcasting unit for broadcasting the data broadcast program whose constitution has been changed.

The stated object can also be achieved by a transmission apparatus for repeatedly transmitting a plurality of data elements that constitute a data broadcast program to a broadcast apparatus, including: a control information generating unit for generating control information for instructing the broadcast apparatus to perform change processing on a constitution of the data broadcast program; and a transmitting unit for transmitting the control information to the broadcast apparatus. Here, the transmission apparatus may further include: an obtaining unit for obtaining a transport stream in which video data, audio data, and the plurality of data elements have been multiplexed, wherein the control information generating unit multiplexes the control information in the obtained transport stream, and the transmitting unit transmits the transport stream in which the control information has been multiplexed, to the broadcast apparatus. As an alternative, the transmission apparatus may further include: an obtaining unit for obtaining a video signal, wherein the control information generating unit superimposes the control information on the obtained video signal, and the transmitting unit transmits the video signal on which the control information has been superimposed, to the broadcast apparatus. As an alternative, the transmission apparatus may further include: an obtaining unit for obtaining video and audio data, wherein the control information generating unit multiplexes the control information in the obtained video and audio data, and the transmitting unit transmits the video and audio data in which the control information has been multiplexed, to the broadcast apparatus. Here, the control information generating unit may describe the control information in a DII (Download Info Indication) message, and output the DII message and the plurality of data elements according to a DSM-CC (Digital Storage Media-Command and Control) data carousel transmission method, wherein the transmitting unit transmits the DII message and the plurality of data elements output from the control information generating unit, to the broadcast apparatus. As an alternative, the control information generating unit may describe the control information in a DDB (Download Data Block) message, and output the DDB message and the plurality of data elements according to a DSM-CC (Digital Storage Media-Command and Control) data carousel transmission method, wherein the transmitting unit transmits the DDB message and the plurality of data elements output from the control information generating unit, to the broadcast apparatus.

The stated object can also be achieved by a broadcast apparatus for receiving a plurality of data elements from a transmission apparatus and broadcasting the plurality of data elements, the transmission apparatus repeatedly transmitting the plurality of data elements that constitute a data broadcast program, including: a receiving unit for receiving control information from the transmission apparatus, the control information instructing the broadcast apparatus to perform change processing on a constitution of the data broadcast program; a changing unit for performing the change processing on the constitution of the data broadcast program according to the control information; and a broadcasting unit for broadcasting the data broadcast program whose constitution has been changed.

With these constructions, the constitution of the data broadcast program transmitted from the transmission apparatus which is a key station to the broadcast apparatus which is a local station is changed so as to fit the needs of local viewers, under control of the key station. This enables the key station to organize the contents of the data broadcast program to better meet local viewers' needs.

Here, the control information may include data element information, type information, and time information, the data element information specifying a data element out of the plurality of data elements which is subjected to the change processing, the type information showing a type of the change processing, and the time information showing a time for performing the change processing, wherein the broadcast apparatus further includes: a storing unit for storing a replacement data element that is associated with the data element information, the replacement data element being a data element which is to replace the data element specified by the data element information, and the changing unit includes: a type judging unit for judging the type of the change processing shown by the type information; a deleting unit for deleting, if the type of the change processing is replacement, the data element specified by the data element information from the plurality of data elements when the time shown by the time information has come; and an outputting unit for reading the replacement data element associated with the data element information from the storing unit, and outputting the read replacement data element and the plurality of data elements except the deleted data element.

With this construction, the key station designates a data element in the data broadcast program which can be replaced by a local station. That is, the key station can control the local station to replace the data element with a local viewer-targeted data element to fit the needs of local viewers, while maintaining the basic data broadcast programming.

Here, the data broadcast program control system may include a plurality of broadcast apparatuses, wherein the control information further includes apparatus information specifying which of the plurality of broadcast apparatuses is to perform the change processing, the changing unit further includes: an apparatus judging unit for judging whether the broadcast apparatus is specified by the apparatus information, and the changing unit performs the change processing, only if the broadcast apparatus is specified by the apparatus information.

With this construction, only a selected local station is allowed to change a data element to a local viewer-targeted data element. This enables the key station to organize the contents of the data broadcast program for each local station to better meet local viewers' needs. For example, only a local station located in a specific area may change the contents of the data broadcast program to a local election news bulletin, event information, or a typhoon warning. In this way, necessary information can be provided to local viewers of the local station.

Here, the control information may include data element information, type information, time information, and a replacement data element, the data element information specifying a data element out of the plurality of data elements which is subjected to the change processing, the type information showing a type of the change processing, the time information showing a time for performing the change processing, and the replacement data element being a data element which is to replace the data element specified by the data element information, wherein the changing unit includes: a type judging unit for judging the type of the change processing shown by the type information; a deleting unit for deleting, if the type of the change processing is replacement, the data element specified by the data element information from the plurality of data elements when the time shown by the time information has come; an acquiring unit for acquiring the replacement data element included in the control information; and an outputting unit for outputting the acquired replacement data element and the plurality of data elements except the deleted data element.

This enables the key station to control both the timing and contents of replacement. Hence the key station can organize the contents of the data broadcast program efficiently. For instance, the key station may control a local station to change a data broadcast commercial of some manufacturer's product to a data broadcast commercial of the manufacturer's another product which is likely to attract more interest from local viewers.

Here, the data broadcast program control system may include a plurality of broadcast apparatuses, wherein the control information further includes apparatus information specifying which of the plurality of broadcast apparatuses is to perform the change processing, the changing unit further includes: an apparatus judging unit for judging whether the broadcast apparatus is specified by the apparatus information, and the changing unit performs the change processing, only if the broadcast apparatus is specified by the apparatus information.

This enables the key station to select suitable information from its own database and transmit it to a selected local station. Accordingly, the key station can organize the contents of the data broadcast program for each local station to better meet local viewers' needs. For instance, by repeatedly transmitting event-related commercials to a local station covering an area where an event such as a festival is taking place, the key station can make efficient advertisements.

Here, the control information may include type information and time information, the type information showing a type of the change processing, and the time information showing a time for performing the change processing, wherein the broadcast apparatus further includes: a storing unit for storing an addition data element which is a data element to be added to the plurality of data elements, and the changing unit includes: a type judging unit for judging the type of the change processing shown by the type information; a reading unit for reading, if the type of the change processing is addition, the addition data element from the storing unit when the time shown by the time information has come; and an outputting unit for outputting the read addition data element and the plurality of data elements.

Also, the plurality of data elements may be a plurality of modules which each include a plurality of resources, wherein the control information includes module information, type information, and time information, the module information specifying a module out of the plurality of modules which is subjected to the change processing, the type information showing a type of the change processing, and the time information showing a time for performing the change processing, the broadcast apparatus further includes: a storing unit for storing an addition resource which is a resource to be added to the module specified by the module information, and the changing unit includes: a type judging unit for judging the type of the change processing shown by the type information; an acquiring unit for acquiring, if the type of the change processing is addition, the module specified by the module information when the time shown by the time information has come; and an outputting unit for reading the addition resource from the storing unit, adding the read addition resource to the acquired module, and outputting the plurality of modules in which the addition resource has been added to the module.

With this construction, the key station controls a local station to add a local viewer-targeted data element, without deleting any of the data elements that constitute the key station-originated data broadcast program. Which is to say, the key station can control the local station to add a data element which fits local viewers' needs, while maintaining the key station's original data broadcast programming.

Here, the storing unit may store one or more addition data elements which are each associated with a transmission time slot for transmitting the addition data element, wherein the reading unit reads an addition data element that is associated with a transmission time slot which includes the time shown by the time information.

With this construction, a data element that fits local viewers' needs can be selected and added according to time slot.

Here, the data broadcast program control system may include a plurality of broadcast apparatuses, wherein the control information further includes apparatus information specifying which of the plurality of broadcast apparatuses is to perform the change processing, the changing unit further includes: an apparatus judging unit for judging whether the broadcast apparatus is specified by the apparatus information, and the changing unit performs the change processing, only if the broadcast apparatus is specified by the apparatus information.

With this construction, only a selected local station is allowed to select and add a data element that fits local viewers' needs, according to time slot.

Here, the control information may include type information, time information, and an addition data element, the type information showing a type of the change processing, the time information showing a time for performing the change processing, and the addition data element being a data element which is to be added to the plurality of data elements, wherein the changing unit includes: a type judging unit for judging the type of the change processing shown by the type information; an acquiring unit for acquiring, if the type of the change processing is addition, the addition data element included in the control information when the time shown by the time information has come; and an outputting unit for outputting the acquired addition data element and the plurality of data elements.

Also, the plurality of data elements may be a plurality of modules which each include a plurality of resources, wherein the control information includes module information, type information, time information, and an addition resource, the module information specifying a module out of the plurality of modules which is subjected to the change processing, the type information showing a type of the change processing, the time information showing a time for performing the change processing, and the addition resource being a resource which is to be added to the module specified by the module information, and the changing unit includes: a type judging unit for judging the type of the change processing shown by the type information; an acquiring unit for acquiring, if the type of the change processing is addition, the module specified by the module information and the addition resource included in the control information when the time shown by the time information has come; and an outputting unit for adding the acquired addition resource to the acquired module, and outputting the plurality of modules in which the addition resource has been added to the module.

This enables the key station to select a data element that fits local viewers' needs, without deleting any of the data elements that constitute the key station-originated data broadcast program. Accordingly, the key station can add a local viewer-targeted data element while maintaining the original data broadcast programming.

Here, the data broadcast program control system may include a plurality of broadcast apparatuses, wherein the control information further includes apparatus information specifying which of the plurality of broadcast apparatuses is to perform the change processing, the changing unit further includes: an apparatus judging unit for judging whether the broadcast apparatus is specified by the apparatus information, and the changing unit performs the change processing, only if the broadcast apparatus is specified by the apparatus information.

This enables the key station to select a data element that fits local viewers' needs for a selected local station, without deleting any of the data elements that constitute the key station-originated data broadcast program. Accordingly, the key station can add a local viewer-targeted data element for each local station, while maintaining the original data broadcast programming.

Here, the control information may include data element information, type information, and time information, the data element information specifying a data element out of the plurality of data elements which is subjected to the change processing, the type information showing a type of the change processing, and the time information showing a time for performing the change processing, wherein the changing unit includes: a type judging unit for judging the type of the change processing shown by the type information; a deleting unit for deleting, if the type of the change processing is deletion, the data element specified by the data element information from the plurality of data elements when the time shown by the time information has come; and an outputting unit for outputting the plurality of data elements except the deleted data element.

With this construction, the key station prohibits a local station from broadcasting part of the key station-originated data broadcast program if necessary. Hence it is possible to avoid broadcasting unnecessary programs.

Here, the data broadcast program control system may include a plurality of broadcast apparatuses, wherein the control information further includes apparatus information specifying which of the plurality of broadcast apparatuses is to perform the change processing, the changing unit further includes: an apparatus judging unit for judging whether the broadcast apparatus is specified by the apparatus information, and the changing unit performs the change processing, only if the broadcast apparatus is specified by the apparatus information.

With this construction, the key station prohibits a selected local station from broadcasting part of the key station-originated data broadcast program if necessary. This makes it possible to avoid broadcasting programs which are unnecessary for local viewers.

Here, the control information may include type information and time information, the type information showing a type of the change processing, and the time information showing a time for performing the change processing, wherein the broadcast apparatus further includes: a storing unit for storing one or more addition event messages that are each associated with a transmission time slot for transmitting the addition event message, and the changing unit includes: a type judging unit for judging the type of the change processing shown by the type information; a reading unit for reading, if the type of the change processing is addition, an addition event message from the storing unit when the time shown by the time information has come, the read addition event message being associated with a transmission time slot that includes the time shown by the time information; and an outputting unit for outputting the read addition event message and the plurality of data elements.

With this construction, the key station controls a local station to add an event message stored in the local station to the data broadcast program if necessary.

Here, the data broadcast program control system may include a plurality of broadcast apparatuses, wherein the control information further includes apparatus information specifying which of the plurality of broadcast apparatuses is to perform the change processing, the changing unit further includes: an apparatus judging unit for judging whether the broadcast apparatus is specified by the apparatus information, and the changing unit performs the change processing, only if the broadcast apparatus is specified by the apparatus information.

With this construction, the key station controls a selected local station to add an event message stored in the local station to the data broadcast program if necessary.

Here, the control information may include a script that shows a procedure of the change processing, wherein the changing unit performs the change processing in accordance with the procedure shown by the script.

With this construction, the key station controls a local station to change data broadcast programming according to a procedure shown by a transmitted script.

Here, the data broadcast program control system may include a plurality of broadcast apparatuses, wherein the control information further includes apparatus information specifying which of the plurality of broadcast apparatuses is to perform the change processing, the changing unit further includes: an apparatus judging unit for judging whether the broadcast apparatus is specified by the apparatus information, and the changing unit performs the change processing, only if the broadcast apparatus is specified by the apparatus information.

With this construction, the key station controls a selected local station to change data broadcast programming according to a procedure shown by a transmitted script.

Here, the control information may include type information, time information, and an addition event message, the type information showing a type of the change processing, the time information showing a time for performing the change processing, and the addition event message being an event message which is to be added to the plurality of data elements, wherein the changing unit includes: a type judging unit for judging the type of the change processing shown by the type information; an acquiring unit for acquiring, if the type of the change processing is addition, the addition event message included in the control information when the time shown by the time information has come; and an outputting unit for outputting the acquired addition event message and the plurality of data elements.

With this construction, the key station controls a local station to add an event message produced by the key station to the data broadcast program if necessary. For example, when an important event occurs, the key station may produce an event message concerning the event and transmit it to the local station so that the event message is broadcast from the local station.

Here, the data broadcast program control system may include a plurality of broadcast apparatuses, wherein the control information further includes apparatus information specifying which of the plurality of broadcast apparatuses is to perform the change processing, the changing unit further includes: an apparatus judging unit for judging whether the broadcast apparatus is specified by the apparatus information, and the changing unit performs the change processing, only if the broadcast apparatus is specified by the apparatus information.

With this construction, the key station controls a selected local station to add an event message produced by the key station to the data broadcast program if necessary. For example, when an earthquake happens in some area, the key station may produce an event message showing earthquake information and transmit it to a local station which covers the area, so that the event message is broadcast from that local station.

### BRIEF DESCRIPTION OF DRAWINGS

FIG. 1 shows a construction of a main part of a data broadcast program control system in the first embodiment of the present invention.

FIG. 2 is a conceptual diagram showing an example stream of modules that constitute a data broadcast program which is transmitted from a first broadcast apparatus shown in FIG. 1.

FIG. 3 shows an example of TOC (table of contents) information.

FIG. 4 shows an example of data broadcast control information in the first embodiment.

FIG. 5 shows an example of a resource.

FIG. 6 shows an example of a resource table.

FIG. 7 is a flowchart showing an operation of module replacement processing performed by a data processing unit shown in FIG. 1.

FIG. 8 shows a construction of a main part of a data broadcast program control system in the second embodiment of the present invention.

FIG. 9 shows an example of addition control information in the second embodiment.

FIG. 10 shows an example of an addition module table and addition resource table.

FIG. 11 is a flowchart showing an operation of addition data addition processing performed by a data processing unit shown in FIG. 8.

FIG. 12 is a flowchart showing an operation of module addition processing performed by the data processing unit.

FIG. 13 shows a construction of a main part of a data broadcast program control system in the third embodiment of the present invention.

FIG. 14 shows an example of data broadcast control information in the third embodiment.

FIG. 15 is a flowchart showing an operation of module deletion processing performed by a data processing unit shown in FIG. 13.

FIG. 16 shows a construction of a main part of a data broadcast program control system in the fourth embodiment of the present invention.

FIG. 17 shows an example of data broadcast control information in the fourth embodiment.

FIG. 18 is a flowchart showing an operation of module replacement processing performed by a data processing unit shown in FIG. 16.

FIG. 19 shows a construction of a main part of a data broadcast program control system in the fifth embodiment of the present invention.

FIG. 20 shows an example of addition control information in the fifth embodiment.

FIG. 21 is a flowchart showing an operation of addition data addition processing performed by a data processing unit shown in FIG. 19.

FIG. 22 is a functional block diagram showing a construction of a first broadcast apparatus which is a modification to the embodiments.

FIG. 23 is a functional block diagram showing a construction of a first broadcast apparatus which is another modification to the embodiments.

FIG. 24 is a functional block diagram showing a construction of a first broadcast apparatus which is another modification to the embodiments.

FIG. 25 is a functional block diagram showing a construction of a first broadcast apparatus which is another modification to the embodiments.

FIG. 26 is a functional block diagram showing a construction of a first broadcast apparatus which is another modification to the embodiments.

FIG. 27 is a functional block diagram showing a construction of a first broadcast apparatus which is another modification to the embodiments.

FIG. 28 is a functional block diagram showing a construction of a first broadcast apparatus which is another modification to the embodiments.

FIG. 29 is a flowchart showing an operation of resource addition processing performed by the data processing unit shown in FIG. 8.

FIG. 30 is a flowchart showing an operation of event message addition processing performed by the data processing unit shown in FIG. 8.

FIG. 31 is a flowchart showing an operation of module addition processing performed by the data processing unit shown in FIG. 19.

FIG. 32 is a flowchart showing an operation of resource addition processing performed by the data processing unit shown in FIG. 19.

FIG. 33 is a flowchart showing an operation of event message addition processing performed by the data processing unit shown in FIG. 19.

FIG. 34 is a flowchart showing an operation of resource replacement processing performed by the data processing unit shown in FIG. 1.

FIG. 35 is a flowchart showing an operation of resource deletion processing performed by the data processing unit shown in FIG. 13.

FIG. 36 is a flowchart showing an operation of resource replacement processing performed by the data processing unit shown in FIG. 16.

### BEST MODE FOR CARRYING OUT THE INVENTION

First Embodiment

The following is a description of a data broadcast program control system to which the first embodiment of the present invention relates, with reference to drawings.

(Construction)

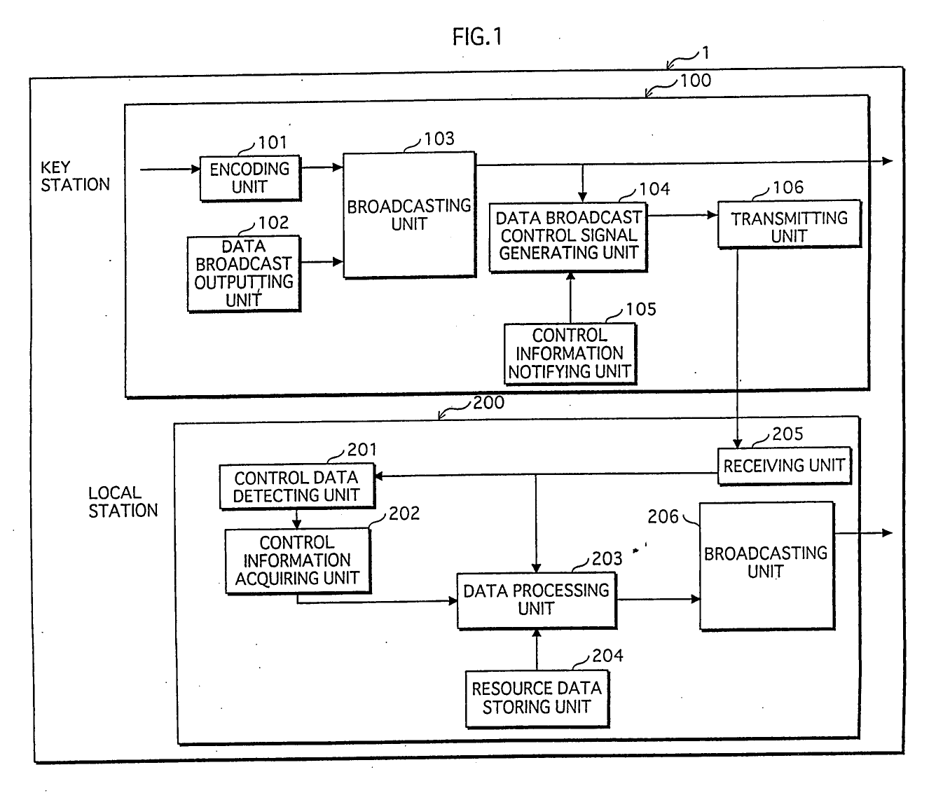

FIG. 1 shows a construction of a main part of a data broadcast program control system 1 in the first embodiment of the present invention. The data broadcast program control system 1 is roughly made up of a broadcast apparatus 100 of a key station (hereafter a “first broadcast apparatus 100”) and a broadcast apparatus 200 of a local station (hereafter a “second broadcast apparatus 200”). The first broadcast apparatus 100 transmits a transport stream in which video data, audio data, and data for data broadcasting such as still picture and text information (hereafter such data is called “data broadcast data”) are multiplexed. The second broadcast apparatus 200 receives the transport stream from the first broadcast apparatus 100, and broadcasts it.

Here, the number of first broadcast apparatuses 100 may not be limited to one.

Likewise, the number of second broadcast apparatuses 200 may not be limited to one.

The transport stream referred to here is obtained as follows. Each of video data, audio data, and data broadcast data that constitute a broadcast program is divided into packets of fixed length (188 bytes) to which necessary information has been attached. Data of these packets (hereafter “packet data”) is then arranged sequentially to form one data stream. This data stream is the transport stream. Transport streams are widely utilized in digital broadcasting. Various types of data including video data, audio data, and data broadcast data are multiplexed and transmitted in a transport stream.

In terms of hardware, the data broadcast program control system 1 is realized by a CPU, a ROM, a RAM, a hard disk, a decoder, a filter, and the like. The functions of the data broadcast program control system 1 are realized by the CPU executing a computer program stored in the ROM or the hard disk. The same applies to data broadcast program control systems 2 to 5 which are described later.

A construction of the first broadcast apparatus 100 is described first. The first broadcast apparatus 100 includes an encoding unit 101, a data broadcast outputting unit 102, a broadcasting unit 103, a data broadcast control signal generating unit 104, a control information notifying unit 105, and a transmitting unit 106.

The encoding unit 101 compression-encodes video and audio data which is input in the first broadcast apparatus 100, and divides the result into packet data. The encoding unit 101 then attaches PIDs (described later) to these packet data, and outputs the result to the broadcasting unit 103.

As one example, the compression-encoding is performed according to an MPEG2 compression method.

The control information notifying unit 105 receives input of data broadcast control information from an operator, and outputs it to the data broadcast control signal generating unit 104. Though the data broadcast control information is input by the operator in this example, instead the data broadcast control information may by stored in a memory beforehand, so that the control information notifying unit 105 reads the data broadcast control information from the memory at a predetermined time and outputs it to the data broadcast control signal generating unit 104.

The data broadcast control information is the following. For a data broadcast program transmitted from the first broadcast apparatus 100, the data broadcast control information designates a component (hereafter a “module”) of the data broadcast program that is subjected to change processing. The data broadcast control information also instructs the second broadcast apparatus 200 to perform the change processing on the designated module.

Such data broadcast control information may be multiplexed in the form of PES (Packetized Elementary Stream) or section in MPEG2.

Each module is made up of a plurality of sets of packet data (hereafter “module packet data”). Each set of module packet data is accompanied by identification information including a PID, a module ID, and a resource name.

The PID is an identifier for identifying a data type. This enables the second broadcast apparatus 200 to identify, for instance, whether the module packet data transmitted from the first broadcast apparatus 100 is video data, audio data, or data broadcast data.

The module ID is an identifier for identifying a module to which the module packet data belongs.

The resource name is an identifier for identifying a resource which is included in the module.

The resource is a component part of the module, such as a BML (Broadcast Markup Language) document file written in a markup language or a file of image data. Data of the resource may include link information for designating, as a link destination, a resource name of another resource contained in the same module or in another module.

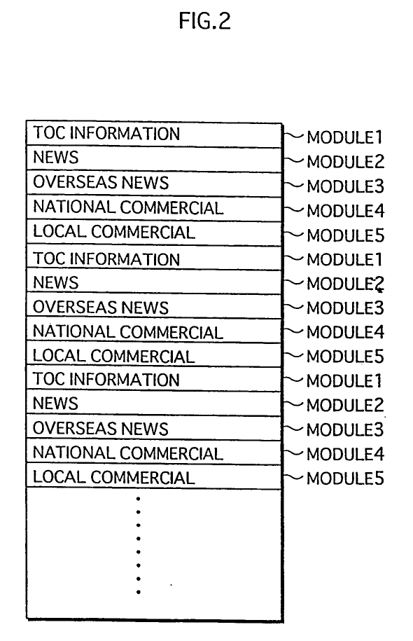

FIG. 2 is a conceptual diagram showing an example stream of modules that constitute a data broadcast program which is transmitted from the first broadcast apparatus 100. In the drawing, the data broadcast program is made up of modules 1 to 5 which respectively show TOC (table of contents) information, news, overseas news, national commercials, and local commercials. Each module is transmitted from the first broadcast apparatus 100 repeatedly at predetermined time intervals.

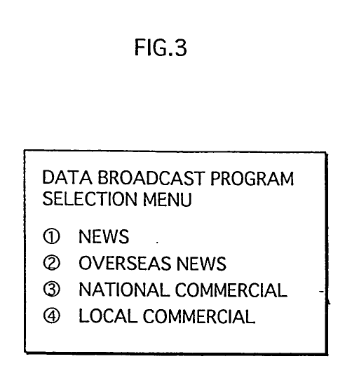

The TOC information is a module showing a menu selection image which is to be displayed first when a user selects a data broadcast reception selection button on a remote control of a data broadcast reception apparatus. FIG. 3 shows an example of TOC information. A menu selection image shown by this TOC information includes link buttons (\mathring{1} to \mathring{4}) for receiving the user's indication of a module ID shown by a selection menu, and displaying an image shown by a module identified by the indicated module ID on the screen. When the user selects a link button, the data broadcast reception apparatus receives each set of module packet data which has a module ID corresponding to the selected link button. The data broadcast reception apparatus then displays an image shown by a module which is made up of the received sets of module packet data, on the screen.

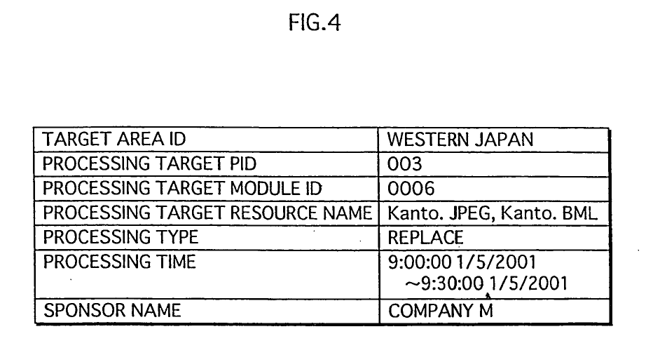

FIG. 4 shows an example of the data broadcast control information. This data broadcast control information is made up of information showing a target area ID, a processing target PID, a processing target module ID, a processing target resource name, a processing type, a processing time, and a sponsor name.

The data broadcast control information may also include a material code (an identification code used by a broadcast station).

The target area ID is an identifier for identifying a geographical area which is subjected to processing shown by the processing type. Suppose the target area ID shows “Western Japan”. If the second broadcast apparatus 200 is located in western Japan, the second broadcast apparatus 200 performs the processing shown by the processing type on a data broadcast program transmitted from the first broadcast apparatus 100, upon receiving this data broadcast control information. If the second broadcast apparatus 200 is located in eastern Japan, on the other hand, the second broadcast apparatus 200 broadcasts the data broadcast program transmitted from the first broadcast apparatus 100, as it is.

Here, the second broadcast apparatus 200 holds an area ID for identifying a geographical area to which the second broadcast apparatus 200 belongs. This being so, the second broadcast apparatus 200 judges whether to perform the processing shown by the processing type, by judging whether the held area ID matches the received target area ID.

The processing target PID is a PID for identifying a data broadcast program that is subjected to the processing shown by the processing type, in a transport stream transmitted from the first broadcast apparatus 100. In FIG. 4, the processing target PID is “003”.

The processing target module ID is a module ID for identifying a module that is subjected to the processing, in the data broadcast program identified by the processing target PID. In FIG. 4, the processing target module ID is “0006”.

The processing target resource name is an identifier for identifying a resource that is subjected to the processing, in the module identified by the processing target module ID. In FIG. 4, two resources “Kanto.JPEG” and “Kanto.BML” are designated.

If the processing target resource name is undesignated, it means every resource that constitutes the module identified by the processing target module ID is subjected to the processing. Which is to say, the whole module is subjected to the processing.

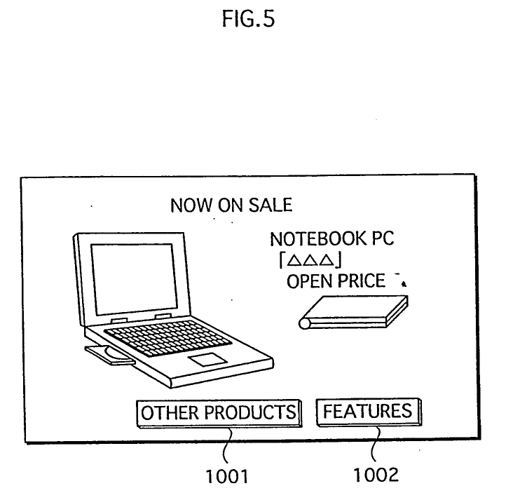

FIG. 5 shows an example resource. In the drawing, a resource showing an image of a notebook PC (personal computer) commercial is displayed with lower right selection buttons 1001 and 1002 including link information to other resources.

The processing type shows the type of processing which is to be performed by the second broadcast apparatus 200. In FIG. 4, the processing type is “replace”.

The processing time shows a time for performing the processing shown by the processing type. In FIG. 4, the processing time is “nine to nine thirty on May 1, 2001 ”.

The sponsor name is an identifier for identifying a sponsor of the data broadcast program which is subjected to the processing. In FIG. 4, the sponsor name is Company M.

The data broadcast outputting unit 102 encodes each resource that constitutes a data broadcast program, and divides it into module packet data. The data broadcast outputting unit 102 then attaches a predetermined PID, module ID, and resource name to each divided set of module packet data, and outputs the result to the broadcasting unit 103 as data broadcast data.

The broadcasting unit 103 multiplexes the video and audio data received from the encoding unit 101, with the data broadcast data received from the data broadcast outputting unit 102. The broadcasting unit 103 outputs the result to the outside and to the data broadcast control signal generating unit 104, as a transport stream.

The data broadcast control signal generating unit 104 divides the data broadcast control information received from the control information notifying unit 105 into packet data (hereafter “control packet data”). The data broadcast control signal generating unit 104 then attaches a predetermined PID for identifying the data broadcast control information to each divided set of control packet data, and multiplexes the result in the transport stream received from the broadcasting unit 103. The data broadcast control signal generating unit 104 finally outputs the resulting transport stream to the transmitting unit 106.

Here, the data broadcast control information need not be special packet data. Instead, the data broadcast control information may be written in a DII (Download Info Indication) message which is control information used in a DSM-CC (Digital Storage Media Command and Control) data carousel transmission method for transmitting data broadcast data (e.g. the data broadcast control information may be written in a private data area of the DII message). As an alternative, the data broadcast control information may be written in a DDB (Download Data Block) message of DSM-CC in the form of module or resource.

The transmitting unit 106 receives the transport stream including the control packet data from the data broadcast control signal generating unit 104, and transmits it to the second broadcast apparatus 200 via a network line.

A construction of the second broadcast apparatus 200 is described next. The second broadcast apparatus 200 includes a control data detecting unit 201, a control information acquiring unit 202, a data processing unit 203, a resource data storing unit 204, a receiving unit 205, and a broadcasting unit 206.

The receiving unit 205 receives the transport stream from the transmitting unit 106, and outputs it to the control data detecting unit 201 and the data processing unit 203.

The control data detecting unit 201 detects the control packet data from the transport stream received from the receiving unit 205, based on the predetermined PID. The control data detecting unit 201 outputs the detected control packet data to the control information acquiring unit 202.

The control information acquiring unit 202 decodes the control packet data received from the control data detecting unit 201, to acquire the data broadcast control information. The control information acquiring unit 202 outputs the data broadcast control information to the data processing unit 203.

The data processing unit 203 replaces a resource or module which is included in the data broadcast program, according to the data broadcast control information received from the control information acquiring unit 202.

In more detail, the data processing unit 203 performs resource replacement processing as follows.

When the processing time shown by the data broadcast control information received from the control information acquiring unit 202 has come, the data processing unit 203 decodes the transport stream received from the receiving unit 205. The data processing unit 203 then specifies module packet data of a module using the processing target PID and processing target module ID shown by the data broadcast control information. The data processing unit 203 reconstructs the module from the module packet data. The data processing unit 203 then specifies a resource which is subjected to replacement, using the processing target resource name shown by the data broadcast control information. The data processing unit 203 deletes the specified resource from the reconstructed module. After this, with reference to a resource table (described later) stored in the resource data storing unit 204, the data processing unit 203 specifies a replacement resource which is to replace the deleted resource, and reads the replacement resource from the resource data storing unit 204. The data processing unit 203 adds the read replacement resource to the reconstructed module. The data processing unit 203 lastly divides the module into module packet data, and outputs the result to the broadcasting unit 206 together with the module packet data of the modules other than the module identified by the processing target PID and processing target module ID.

Module replacement processing is the same as the aforedescribed resource replacement processing, except that it is unnecessary to reconstruct a module. Which is to say, the data processing unit 203 performs the module replacement processing according to the above description where “the processing target resource name” is changed to “the processing target module ID” and “the resource” to “all resources that constitute the module”.

As a result, the resource identified by the processing target resource name in the data broadcast control information is replaced with the replacement resource stored in the resource data storing unit 204.

Note here that this resource replacement processing is performed in units of module packet data.

This being so, the same PID, module ID, and resource name as the deleted module packet data are attached to the module packet data which is output to the broadcasting unit 206.

The second broadcast apparatus 200 may discard the data broadcast control information once the replacement processing has been completed.

The resource data storing unit 204 stores the resource table and one or more replacement resources.

The resource table is a table used for specifying a replacement resource. In detail, the resource table shows the correspondence between PIDs, module IDs, and resource names of resources which are subjected to replacement, and sponsor names and resource names of replacement resources which are to replace the resources.

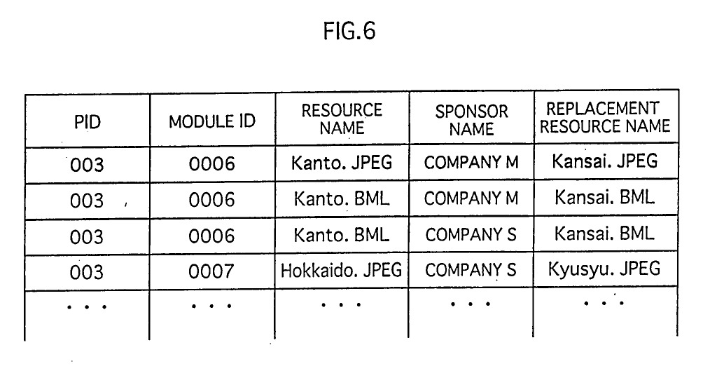

FIG. 6 shows an example of the resource table. This resource table has PID, module ID, and resource name columns for resources which are subjected to replacement, and sponsor name and replacement resource name columns for corresponding replacement resources.

Suppose the data broadcast apparatus 200 receives the data broadcast control information shown in FIG. 4. The data processing unit 203 specifies resources which are to be replaced, from the processing target PID “0003”, the processing target module ID “0006”, and the processing target resource names “Kanto.JPEG” and “Kanto.BML”. The data processing unit 203 also specifies Company M as the sponsor of the data broadcast program to which the specified resources belong. The data processing unit 203 then deletes the specified resources from the reconstructed module “0006”. The data processing unit 203 then refers to the resource table shown in FIG. 6, and specifies replacement resources “Kansai.JPEG” and “Kansai.BML” which correspond to the specified resources. The data processing unit 203 reads these replacement resources from the resource data storing unit 204, and adds the replacement resources to the reconstructed module. The data processing unit 203 divides the module into module packet data, and outputs the result to the broadcasting unit 206 together with the module packet data of the modules other than the module “0006”.

Here, the resource data storing unit 204 stores one or more replacement resources which are each associated with a sponsor name.

The broadcasting unit 206 multiplexes the module packet data received from the data processing unit 203, and outputs the result as a transport stream. In this way, the data broadcast program is broadcast.

(Operation)

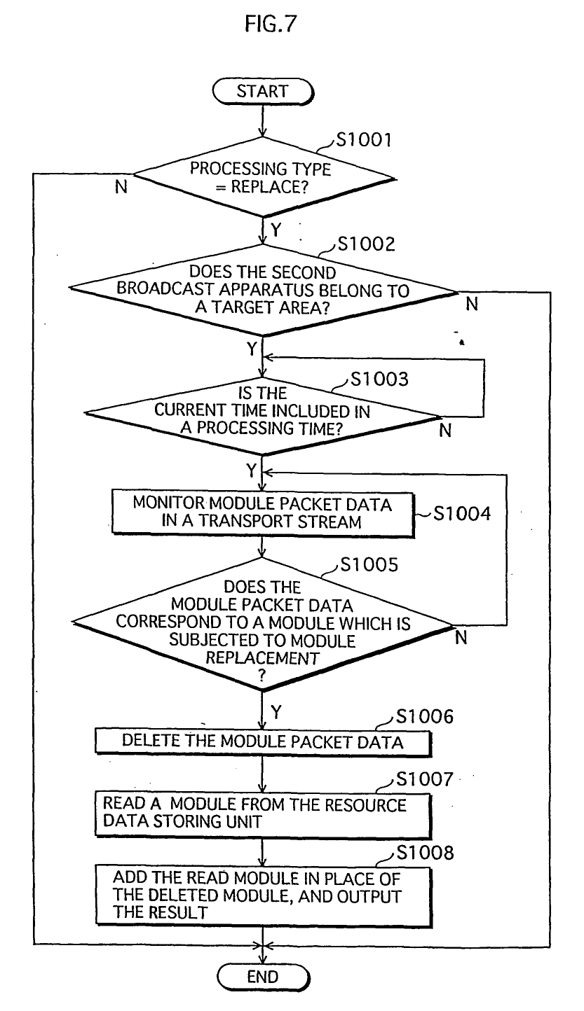

An operation of the module replacement processing performed by the data processing unit 203 is described below. FIG. 7 is a flowchart showing the operation of the module replacement processing.

Upon receiving data broadcast control information from the control information acquiring unit 202, the data processing unit 203 judges whether a processing type shown by the data broadcast control information is “replace” (S1001). If so (S1001:Y), the data processing unit 203 judges whether a target area ID shown by the data broadcast control information matches the area ID held in the data processing unit 203, to judge whether the second broadcast apparatus 200 belongs to a target area (S1002).

If they match (S1002:Y), the data processing unit 203 judges whether the current time is included in a processing time shown by the data broadcast control information (S1003).

If the current time is included in the processing time (S1003:Y), the data processing unit 203 monitors module packet data included in a transport stream which is received from the receiving unit 205 (S1004). The data processing unit 203 judges whether a PID and module ID of the module packet data match a processing target PID and processing target module ID shown by the data broadcast control information, to judge whether the module packet data corresponds to a module which is to be replaced (S1005).

If so (S1005:Y), the data processing unit 203 deletes the module packet data (S1006). The data processing unit 203 then refers to the resource table, and specifies each replacement resource that constitutes a module which is to replace the deleted module, based on the data broadcast control information. The data processing unit 203 reads the specified replacement resources from the resource data storing unit 204 (S1007), and divides them into module packet data. The data processing unit 203 lastly outputs these module packet data to the broadcasting unit 206. In this way, the module in the transport stream is replaced by the different module (S1008).

If the judgement is negative in step S1001 (S1001:N) or S1002 (S1002:N), the data processing unit 203 outputs the received transport stream to the broadcasting unit 206, without performing the replacement processing.

If the judgement is negative in step S1003 (S1003:N), the data processing unit 203 waits until the processing time has come.

If the judgement is negative in step S1005 (S1005:N), the data processing unit 203 returns to step S1004.

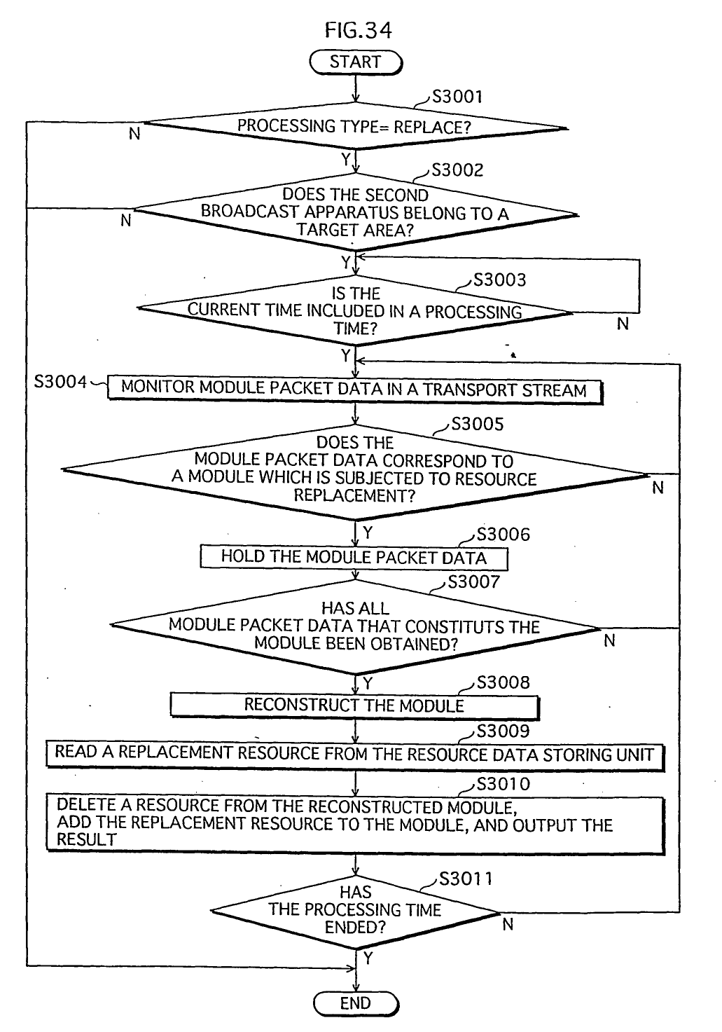

An operation of the resource replacement processing performed by the data processing unit 203 is described next. FIG. 34 is a flowchart showing the operation of the resource replacement processing.

Steps S3001-S3004 in FIG. 34 are the same as steps S1001-S1004 in FIG. 7, so that their explanation has been omitted here.

The data processing unit 203 judges whether module packet data corresponds to a module which contains a resource to be replaced, by comparing a PID and module ID of the module packet data with a processing target PID and processing target module ID shown by data broadcast control information (S3005).

If so (S3005:Y), the data processing unit 203 holds the module packet data (S3006), and judges whether all module packet data that constitutes the module has been obtained (S3007).

If so (S3007:Y), the data processing unit 203 reconstructs the module from the obtained module packet data (S3008). The data processing unit 203 then specifies a replacement resource in the resource table based on the data broadcast control information, and reads the replacement resource from the resource data storing unit 204 (S3009). The data processing unit 203 deletes a resource identified by a processing target resource name in the data broadcast control information from the reconstructed module, and adds the replacement resource to the module. After this, the data processing unit 203 divides the module into module packet data, and outputs the result to the broadcasting unit 206 (S3010). The data processing unit 203 judges whether a processing time shown by the data broadcast control information has ended (S3011). If so (S3011:Y), the data processing unit 203 ends the operation. Otherwise (S3011:N), the data processing unit 203 returns to step S3004.

Second Embodiment

In the first embodiment, the second broadcast apparatus 200 replaces a resource or module included in a data broadcast program which is transmitted from the first broadcast apparatus 100 with another resource or module, and broadcasts the resulting data broadcast program. In the second embodiment, the second broadcast apparatus adds a new resource, module, or event message to a data broadcast program which is transmitted from the first broadcast apparatus, and broadcasts the resulting data broadcast program.

The event message referred to here is a message which is transmitted according to an event message transmission method of ARIB STD-B24. That is, the event message is a message transmitted from a broadcast station to a reception apparatus, to instruct an application operating in the reception apparatus to perform an action designated by the message at once or at a specified time.

In more detail, the event message causes the application to display the contents of the message on an image which is being displayed by the application, or causes the application to perform a predetermined process.

(Construction)

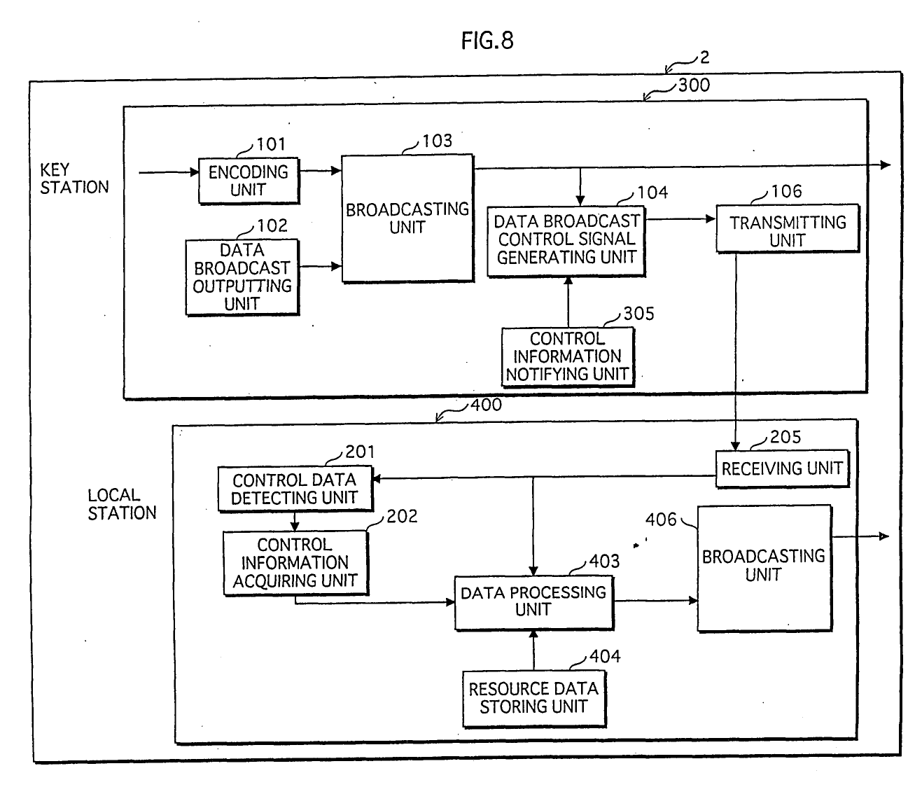

FIG. 8 shows a construction of a main part of a data broadcast program control system 2 to which the second embodiment of the present invention relates. The data broadcast program control system 2 is roughly made up of a first broadcast apparatus 300 and a second broadcast apparatus 400. Here, the number of first broadcast apparatuses 300 may not be limited to one. Likewise, the number of second broadcast apparatuses 400 may not be limited to one.

The first broadcast apparatus 300 includes the encoding unit 101, the data broadcast outputting unit 102, the broadcasting unit 103, the data broadcast control signal generating unit 104, a control information notifying unit 305, and the transmitting unit 106. Construction elements which are the same as those in the first broadcast apparatus 100 in the first embodiment shown in FIG. 1 are given the same reference numerals. The following explanation focuses on the differences with the first embodiment.

The control information notifying unit 305 has a function similar to the control information notifying unit 105 in the first embodiment, but differs in the contents of data broadcast control information which is output to the data broadcast control signal generating unit 104.

The data broadcast control information here is information for adding a new module, resource, or event message to a data broadcast program which is transmitted from the first broadcast apparatus 300 (hereafter such a module, resource, or event message which is to be added is referred to as “addition data”). Such data broadcast control information is hereafter referred to as “addition control information”, to distinguish it from the data broadcast control information used in the first embodiment.

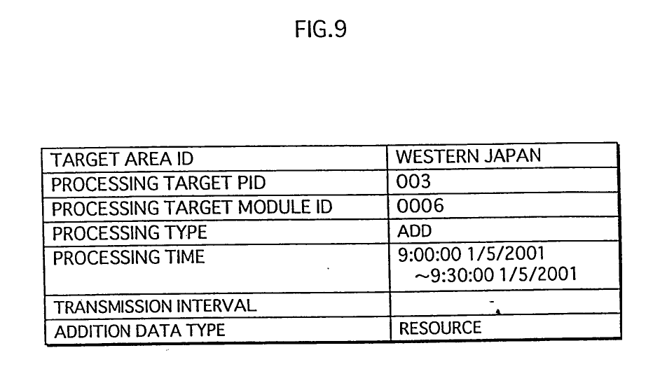

FIG. 9 shows an example of the addition control information. This addition control information is composed of information showing a target area ID, a processing target PID, a processing target module ID, a processing type, a processing time, a transmission interval, and an addition data type.

The target area ID is an identifier for identifying a geographical area which is subjected to processing shown by the processing type.

The processing target PID is a PID for identifying a data broadcast program that is subjected to the processing, in a transport stream transmitted from the first broadcast apparatus 300. In FIG. 9, the processing target PID is “003”.

The processing target module ID is a module ID for identifying a module which is subjected to the processing, in the data broadcast program identified by the processing target PID. In FIG. 9, the processing target module ID is “0006”.

The processing type shows a type of processing to be performed by the second broadcast apparatus 400. In FIG. 9, the processing type is “add”.

The processing time shows a time for performing the processing shown by the processing type. In FIG. 9, the processing time is “nine to nine thirty on May 1, 2001 ”.

The transmission interval shows a time interval with which the second broadcast apparatus 400 broadcasts addition data. This transmission interval is designated when the addition data type is “module” or “event message”. In FIG. 9, the addition data type is “resource”, so that the transmission interval is undesignated.

The addition data type shows whether a type of addition data is “module”, “resource”, or “event message”. In FIG. 9, the addition data type is “resource”.

If the addition data type is “module” or “event message”, the processing target PID and the processing target module ID may be undesignated.

The second broadcast apparatus 400 includes the control data detecting unit 201, the control information acquiring unit 202, a data processing unit 403, a resource data storing unit 404, the receiving unit 205, and a broadcasting unit 406.

Construction elements which are the same as those in the second broadcast apparatus 200 in the first embodiment shown in FIG. 1 are given the same reference numerals, and the following explanation focuses on the differences with the first embodiment.

The data processing unit 403 adds addition data, based on the addition control information received from the control information acquiring unit 202.

In detail, once the processing time shown by the addition control information received from the control information acquiring unit 202 has come, the data processing unit 403 operates as follows. If the addition data type shown by the addition control information is “module” or “resource”, the data processing unit 403 specifies a resource corresponding to a transmission time that includes the current time, and reads the resource from the resource data storing unit 404. The data processing unit 403 divides the read resource into module packet data, and attaches a specified PID, module ID, and resource name to each divided set of module packet data. The data processing unit 403 outputs the result to the broadcasting unit 406. Further, if the addition data type is “module”, the data processing unit 403 outputs the result to the broadcasting unit 406 according to the transmission interval shown by the addition control information.

If the addition data type is “event message”, on the other hand, the data processing unit 403 reads an event message corresponding to a transmission time that includes the current time, from the resource data storing unit 404. The data processing unit 403 outputs the read event message to the broadcasting unit 406, according to the transmission interval shown by the addition control information.

Here, when adding a module or a resource, the data processing unit 403 also rewrites module information (information such as the number of modules, module IDs, and module lengths (byte lengths)) that is described in a DII message.

The data processing unit 403 renews this module information each time addition is performed.

Here, TOC information includes a script for displaying a link button for accepting the user's link indication to a module of each module ID included in the module information.

This allows the user to view an image shown by resources of an added module, by selecting a corresponding link button included in the TOC information.

The data processing unit 403 also outputs a transport stream received from the receiving unit 205, to the broadcasting unit 406.

The resource data storing unit 404 stores an addition module table, an addition resource table, one or more resources, and one or more event messages.

The addition module table is a table for specifying a module that is to be added. In detail, the addition module table shows the correspondence between transmission times and modules.

A transmission time is a time period defined by a transmission start time and a transmission end time. The transmission start time arid the transmission end time are designated by year, date, and time.

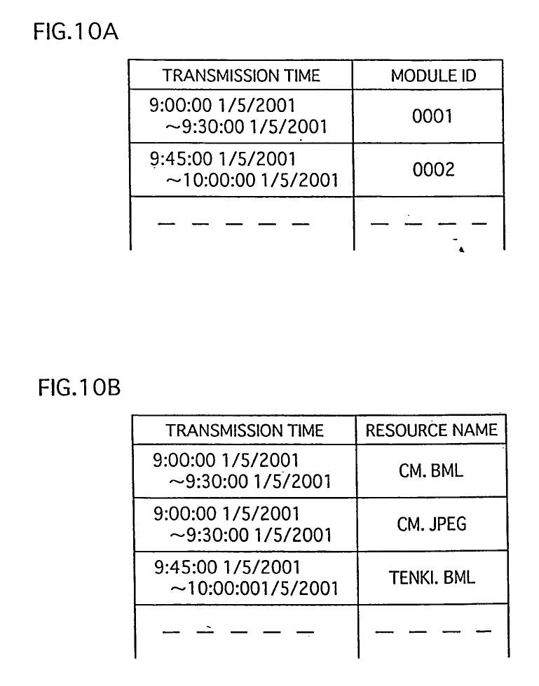

FIG. 10A shows an example of the addition module table. This addition module table has a transmission time column and a module ID column.

FIG. 10B shows an example of the addition resource table. This addition resource table has a transmission time column and a resource name column.

Suppose the second broadcast apparatus 400 receives the addition control information shown in FIG. 9. When the processing time shown by the addition control information has come, the data processing unit 403 refers to the addition resource table shown in FIG. 10B. The data processing unit 403 then specifies resources “CM.BML” and “CM.JPEG” which each correspond to a transmission time that includes the current time.

The resource data storing unit 404 also stores one or more resources used for addition, which are each associated with a PID, module ID, and resource name to be attached to the resource. The resource data storing unit 404 further stores one or more event messages used for addition, which are each associated with a transmission time.

Here, resources that belong to the same module are associated with the same module ID.

The broadcasting unit 406 multiplexes the added module packet data received from the data processing unit 403, in the transport stream received from the data processing unit 403. The broadcasting unit 406 outputs the result.

(Operation)

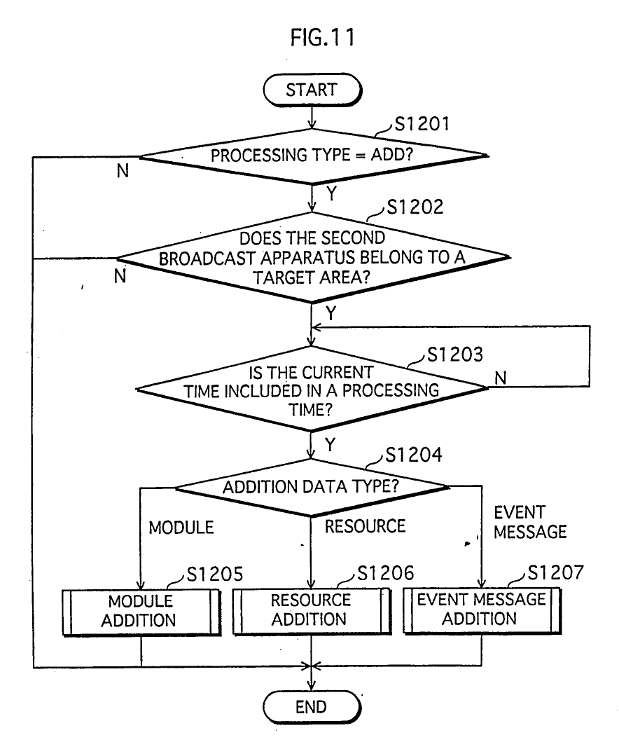

An operation of addition data addition processing performed by the data processing unit 403 is described below. FIG. 11 is a flowchart showing the operation of the addition data addition processing.

Upon receiving addition control information from the control information acquiring unit 202, the data processing unit 403 judges whether a processing type shown by the addition control information is “add” (S1201). If so (S1201:Y), the data processing unit 403 judges whether a target area ID shown by the addition control information matches the area ID held in the data processing unit 403, to judge whether the second broadcast apparatus 400 belongs to a target area (S1202).

If they match (S1202:Y), the data processing unit 403 judges whether the current time is included in a processing time shown by the addition control information (S1203).

If so (S1203:Y), the data processing unit 403 judges an addition data type shown by the addition control information (S1204). If the addition data type is “module”, the data processing unit 403 performs module addition processing (S1205). If the addition data type is “resource”, the data processing unit 403 performs resource addition processing (S1206). If the addition data type is “event message”, the data processing unit 403 performs event message addition processing (S1207).

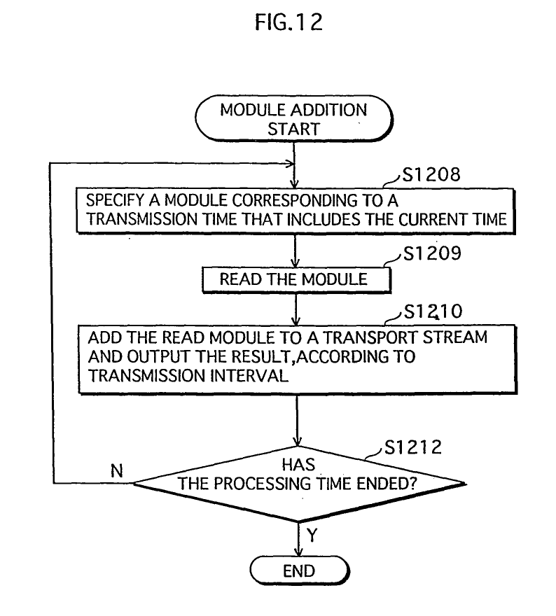

The module addition processing (S1205) performed by the data processing unit 403 is explained below. FIG. 12 is a flowchart showing the module addition processing.

The data processing unit 403 refers to the addition module table in the resource data storing unit 404, to specify a module corresponding to a transmission time that includes the current time (S1208). The data processing unit 403 then reads each resource that constitutes the module from the resource data storing unit 404, together with a corresponding PID and module ID (S1209). The data processing unit 403 generates the module from the read resources, and divides the generated module into module packet data. The data processing unit 403 then attaches the corresponding PID and module ID to each divided set of module packet data. The data processing unit 403 adds the result to a transport stream received from the receiving unit 205 and outputs the transport stream to the broadcasting unit 406, according to a transmission interval shown by the addition control information (S1210). The data processing unit 403 judges whether the processing time shown by the addition control information has ended (S1212). If so (S1212:Y), the data processing unit 403 ends the operation. Otherwise (S1212:N), the data processing unit 403 returns to step S1208.

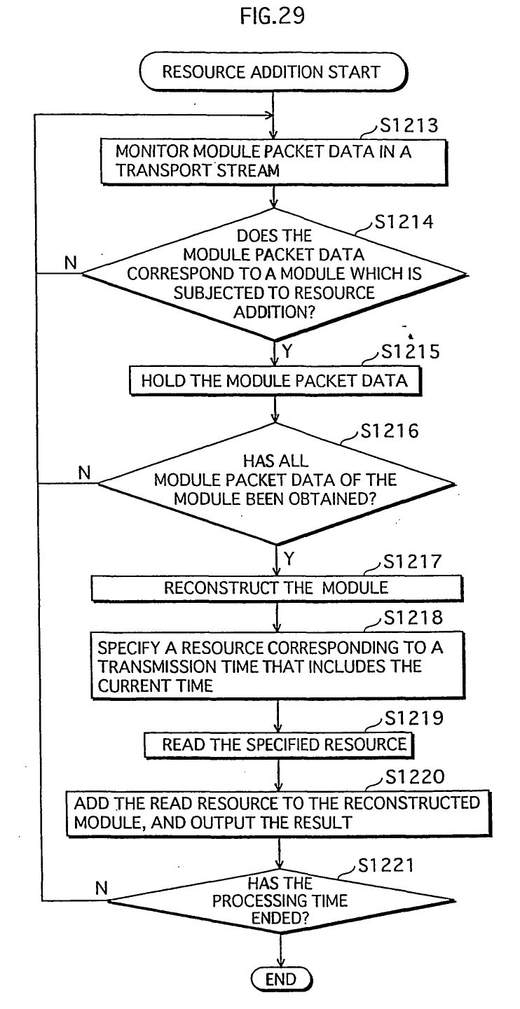

The resource addition processing (S1206) performed by the data processing unit 403 is explained below. FIG. 29 is a flowchart showing the resource addition processing.

The data processing unit 403 monitors module packet data received from the receiving unit 205 (S1213). The data processing unit 403 judges whether the module packet data corresponds to a module to which a resource is to be added, by comparing a PID and module ID of the module packet data with a processing target PID and processing target module ID shown by the addition control information (S1214).

If so (S1214:Y), the data processing unit 403 holds the module packet data (S1215), and judges whether all module packet data that constitutes the module has been obtained (S1216).

If so (S1216:Y), the data processing unit 403 reconstructs the module from the obtained module packet data (S1217). The data processing unit 403 then refers to the addition resource table in the resource data storing unit 404, to specify a resource corresponding to a transmission time that includes the current time (S1218). The data processing unit 403 reads the resource from the resource data storing unit 404 (S1219), and adds the read resource to the reconstructed module. The data processing unit 403 divides the module into module packet data, and outputs the result to the broadcasting unit 406 (S1220). The data processing unit 403 judges whether the processing time shown by the addition control information has ended (S1221). If the processing time has ended (S1221:Y), the data processing unit 403 ends the operation. Otherwise (S1221:N), the data processing unit 403 returns to step S1213.

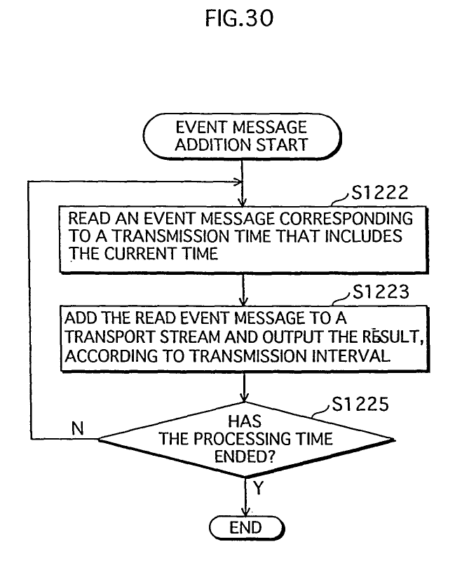

The event message addition processing (S1207) performed by the data processing unit 403 is explained below. FIG. 30 is a flowchart showing the event message addition processing.

The data processing unit 403 reads an event message corresponding to a transmission time that includes the current time, from the resource data storing unit 404 (S1222). The data processing unit 403 adds the read event message to a transport stream received from the receiving unit 205 and outputs the transport stream to the broadcasting unit 406, according to a transmission interval shown by the addition control information (S1223). The data processing unit 403 then judges whether the processing time shown by the addition control information has ended (S1225). If so (S1225:Y), the data processing unit 403 ends the operation. Otherwise (S1225:N), the data processing unit 403 returns to step S1222.

In this way, the second broadcast apparatus 400 adds a module, a resource, or an event message to a transport stream which is transmitted from the first broadcast apparatus 300, based on addition control information transmitted from the first broadcast apparatus 300.

Third Embodiment

In the first embodiment, the second broadcast apparatus 200 replaces a module or resource of a data broadcast program which is transmitted from the first broadcast apparatus 100 with another module or resource, and broadcasts the resulting data broadcast program. In the third embodiment, the second broadcast apparatus deletes a module or resource of a data broadcast program which is transmitted from the first broadcast apparatus, and broadcasts the resulting data broadcast program.

(Construction)

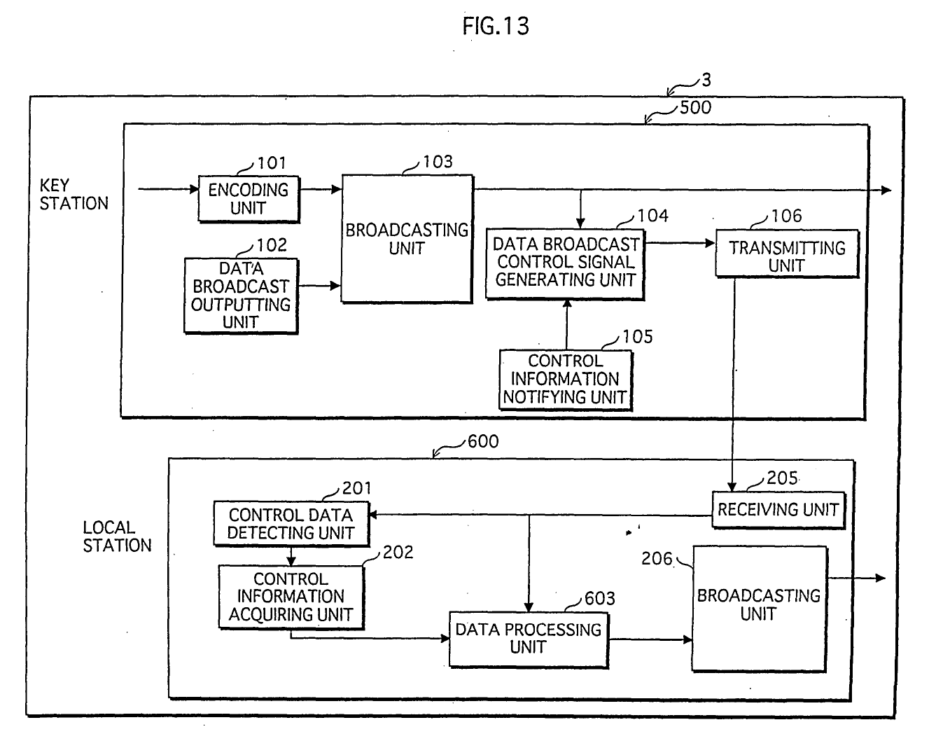

FIG. 13 shows a construction of a main part of a data broadcast program control system 3 to which the third embodiment of the present invention relates. The data broadcast program control system 3 is roughly made up of a first broadcast apparatus 500 and a second broadcast apparatus 600. Here, the number of first broadcast apparatuses 500 may not be limited to one. Likewise, the number of second broadcast apparatuses 600 may not be limited to one.

The first broadcast apparatus 500 has the same construction elements as the first broadcast apparatus 100 in the first embodiment, so that its explanation has been omitted.

The second broadcast apparatus 600 includes the control data detecting unit 201, the control information acquiring unit 202, a data processing unit 603, the receiving unit 205, and the broadcasting unit 206.

Construction elements which are the same as those in the second broadcast apparatus 200 in the first embodiment shown in FIG. 1 are given the same reference numerals, and the following description focuses on the differences with the first embodiment.

The data processing unit 603 deletes a module or a resource, based on data broadcast control information received from the control information acquiring unit 202.

In more detail, module deletion processing is performed as follows. Once the processing time shown by the data broadcast control information received from the control information acquiring unit 202 has come, the data processing unit 603 decodes a transport stream received from the receiving unit 205. The data processing unit 603 specifies module packet data that constitutes a module which is to be deleted, based on the processing target PID and processing target module ID shown by the data broadcast control information. The data processing unit 603 deletes the specified module packet data. The data processing unit 603 then outputs remaining module packet data included in the transport stream, to the broadcasting unit 206.

On the other hand, resource deletion processing is performed as follows. Once the processing time shown by the data broadcast control information received from the control information acquiring unit 202 has come, the data processing unit 603 decodes the transport stream received from the receiving unit 205. The data processing unit 603 specifies module packet data that constitutes a module from which a resource is to be deleted, based on the processing target PID and processing target module ID shown by the data broadcast control information. The data processing unit 603 reconstructs the module from the specified module packet data. The data processing unit 603 then specifies a resource identified by the processing target resource name shown by the data broadcast control information, and deletes the specified resource from the reconstructed module.

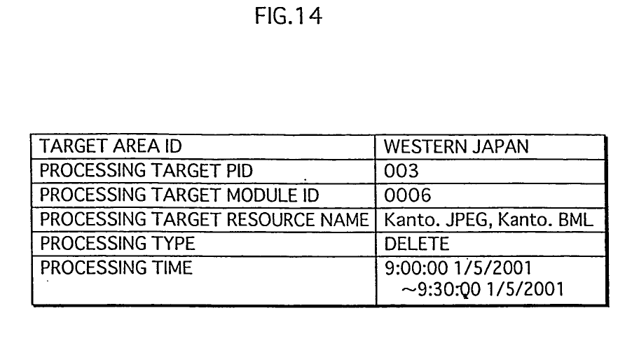

In these cases, the processing type shown by the data broadcast control information received from the control information acquiring unit 202 is “delete”. An example of such data broadcast control information is shown in FIG. 14. This data broadcast control information differs from that shown in FIG. 4, in that the processing type is “delete” and the sponsor name is undesignated.

Here, the processing target module ID and the processing target resource name may be omitted from the data broadcast control information, so that only the processing target PID is designated.

Also, in the module deletion processing, the processing target resource name need not be designated.

In this way, the first broadcast apparatus 500 can designated which data broadcast programs are to be broadcast and which data broadcast programs are not to be broadcast from the second broadcast apparatus 600.

(Operation)

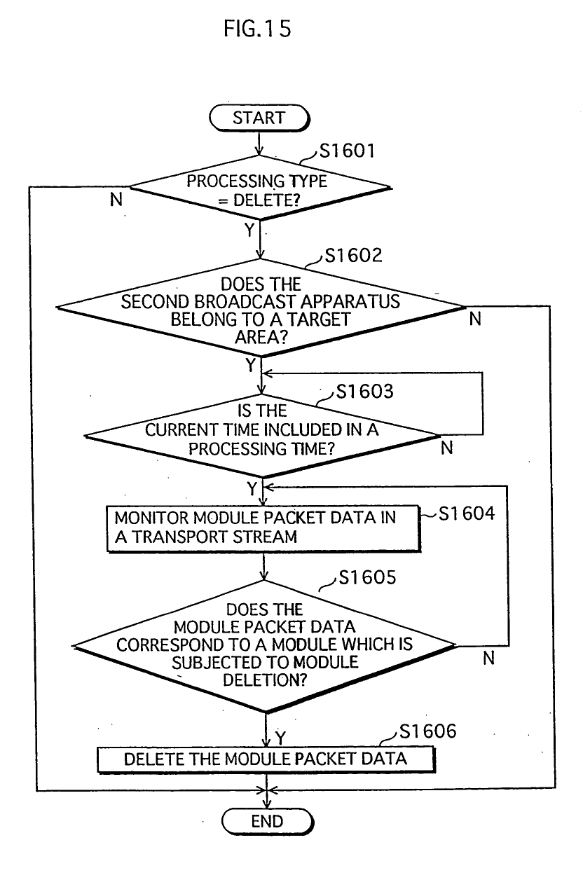

An operation of the module deletion processing performed by the data processing unit 603 is explained below. FIG. 15 is a flowchart showing the operation of the module deletion processing.

Upon receiving data broadcast control information from the control information acquiring unit 202, the data processing unit 603 judges whether a processing type shown by the data broadcast control information is “delete” (S1601). If so (S1601:Y), the data processing unit 603 judges whether a target area ID shown by the data broadcast control information matches the area ID held in the data processing unit 603, to judge whether the second broadcast apparatus 600 belongs to a target area (S1602).

If they match (S1602:Y), the data processing unit 603 judges whether the current time is included in a processing time shown by the data broadcast control information (S1603).

If so (S1603:Y), the data processing unit 603 monitors module packet data included in a transport stream received from the receiving unit 205 (S1604). The data processing unit 603 judges whether the module packet data corresponds to a module which is to be deleted, by comparing a PID and module ID of the module packet data with a processing target PID and processing target module ID shown by the data broadcast control information (S1605).

If so (S1605:Y), the data processing unit 603 deletes the module packet data (S1606).

If the judgement is negative in step S1601 (S1601:N) or S1602 (S1602:N), the data processing unit 603 outputs the transport stream to the broadcasting unit 206, without performing the deletion processing.

If the judgement is negative in step S1603 (S1603:N), the data processing unit 603 waits until the processing time has come.

If the judgement is negative in step S1605 (S1605:N), the data processing unit 603 returns to step S1604.

In the above operation, the data processing unit 603 may delete an event message instead of a module. In such a case, the data broadcast control information includes a processing target event message ID for identifying an event message that is to be deleted, instead of the processing target module ID. Event message deletion processing is the same as the module deletion processing shown in FIG. 15 if “the module” in the description of FIG. 15 is changed to “the event message”, so that its explanation has been omitted.

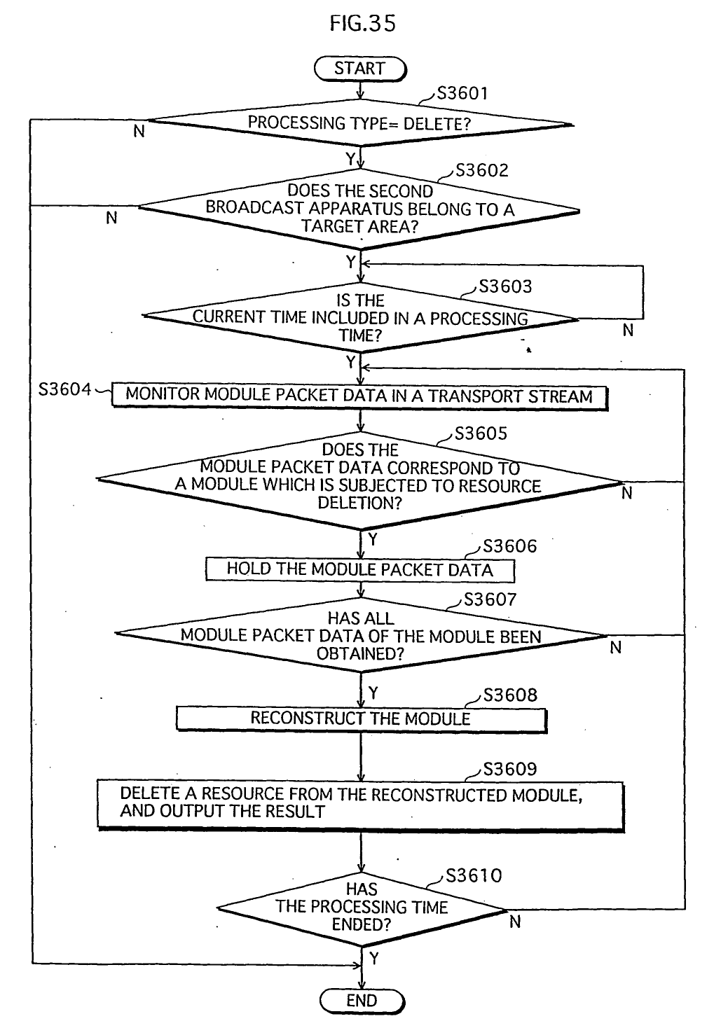

An operation of the resource deletion processing performed by the data processing unit 603 is explained below. FIG. 35 is a flowchart showing the operation of the resource deletion processing.

Steps S3601-S3608 and S3610 are similar to steps S3001-S3008 and S3011 of the resource replacement processing shown in FIG. 34, so that their explanation has been omitted.

The data processing unit 603 deletes a resource from a reconstructed module, based on data broadcast control information (S3609). The data processing unit 603 then divides the module into module packet data, and outputs the result to the broadcasting unit 206.

Fourth Embodiment

In the first embodiment, the second broadcast apparatus 200 stores a replacement resource which is used for replacement. In the fourth embodiment, the first broadcast apparatus transmits a replacement resource to the second broadcast apparatus together with data broadcast control information.

(Construction)

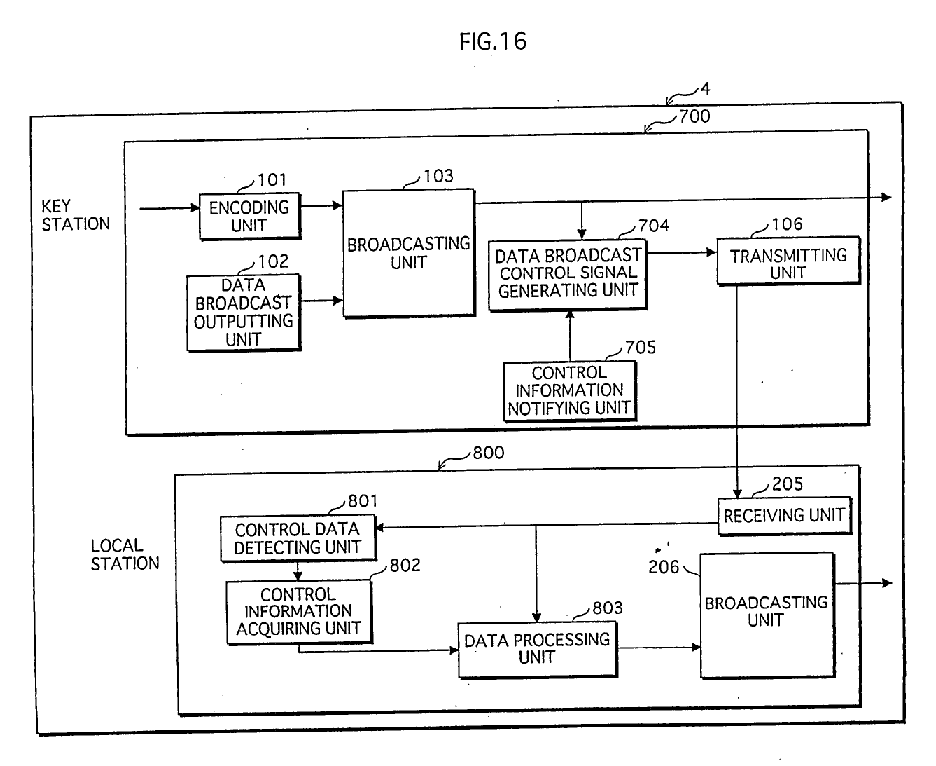

FIG. 16 shows a construction of a main part of a data broadcast program control system 4 to which the fourth embodiment of the present invention relates. The data broadcast program control system 4 is roughly made up of a first broadcast apparatus 700 and a second broadcast apparatus 800. Here, the number of first broadcast apparatuses 700 may not be limited to one. Likewise, the number of second broadcast apparatuses 800 may not be limited to one.

The first broadcast apparatus 700 includes the encoding unit 101, the data broadcast outputting unit 102, the broadcasting unit 103, a data broadcast control signal generating unit 704, a control information notifying unit 705, and the transmitting unit 106. Construction elements which are the same as those in the first broadcast apparatus 100 in the first embodiment shown in FIG. 1 are given the same reference numerals, so that the following description focuses on the differences with the first embodiment.

The control information notifying unit 705 receives input of data broadcast control information and a replacement resource from an operator, and outputs them to the data broadcast control signal generating unit 704.

Here, the replacement resource may be included in the data broadcast control information.

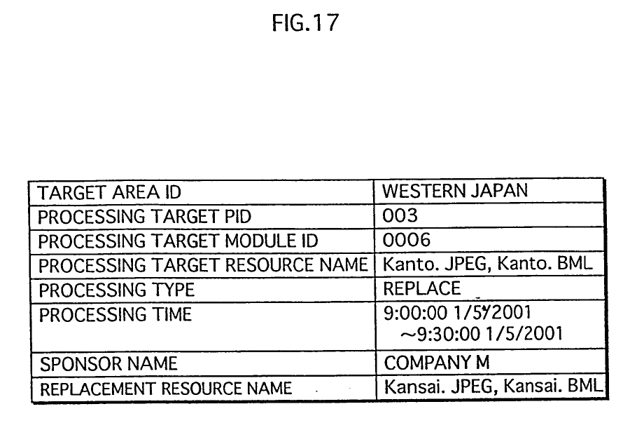

The data broadcast control information has the same contents as the data broadcast control information used in the first embodiment, and also has information showing a replacement resource name. FIG. 17 shows an example of such data broadcast control information.

The replacement resource name is an identifier for identifying the replacement resource. This identifier is attached to the replacement resource.

Though the data broadcast control information and the replacement resource are input by the operator in this example, instead the data broadcast control information and the replacement resource may be stored in a memory beforehand, so that the control information notifying unit 705 reads the data broadcast control information and the replacement resource from the memory and outputs them to the data broadcast control signal generating unit 704 at a predetermined time.

The data broadcast control signal generating unit 704 divides the data broadcast control information and replacement resource received from the control information notifying unit 705, into control packet data. The data broadcast control signal generating unit 704 then attaches a predetermined PID to each divided set of control packet data. The data broadcast control signal generating unit 704 multiplexes the control packet data in a transport stream received from the broadcasting unit 103, and outputs the result to the transmitting unit 106.

The second broadcast apparatus 800 includes a control data detecting unit 801, a control information acquiring unit 802, a data processing unit 803, the receiving unit 205, and the broadcasting unit 206.

Construction elements which are the same as those in the second broadcast apparatus 200 in the first embodiment shown in FIG. 1 are given the same reference numerals, so that the following description focuses on the differences with the first embodiment.

The control data detecting unit 801 detects the control packet data from the transport stream received from the receiving unit 205, based on the predetermined PID. The control data detecting unit 801 outputs the control packet data to the control information acquiring unit 802.

The control information acquiring unit 802 decodes the control packet data received from the control data detecting unit 801, to acquire the data broadcast control information and the replacement resource. The control information acquiring unit 802 outputs the data broadcast control information and the replacement resource to the data processing unit 803.

The data processing unit 803 replaces a module or resource that is a component part of a data broadcast program, based on the data broadcast control information received from the control information acquiring unit 802.

In more detail, module replacement processing is performed as follows. When the processing time shown by the data broadcast control information received from the control information acquiring unit 802 has come, the data processing unit 803 decodes the transport stream received from the receiving unit 205. The data processing unit 803 specifies module packet data of a module which is to be replaced, based on the processing target PID and processing target module ID shown by the data broadcast control information. The data processing unit 803 deletes the specified module packet data. The data processing unit 803 then acquires each replacement resource that constitutes a module which is to replace the deleted module, from the control information acquiring unit 802. The data processing unit 803 generates the module from the acquired replacement resources, and divides the module into module packet data. The data processing unit 803 lastly outputs these module packet data to the broadcasting unit 206.

On the other hand, resource replacement processing is performed as follows. When the processing time shown by the data broadcast control information received form the control information acquiring unit 802 has come, the data processing unit 803 decodes the transport stream received from the receiving unit 205. The data processing unit 803 specifies module packet data of a module which contains a resource to be replaced, based on the processing target PID and processing target module ID shown by the data broadcast control information. The data processing unit 803 reconstructs the module from the module packet data. Following this, the data processing unit 803 specifies a resource identified by the processing target resource name shown by the data broadcast control information, and deletes the specified resource from the reconstructed module. The data processing unit 803 specifies a replacement resource according to the replacement resource name shown by the data broadcast control information, and acquires the replacement resource from the control information acquiring unit 802. The data processing unit 803 adds the replacement resource to the module, and divides the module into module packet data. The data processing unit 803 lastly outputs the result to the broadcasting unit 206.

Here, the same PID, module ID, and resource name as the deleted module packet data are attached to the module packet data that is output to the broadcasting unit 206.

This enables the user to select information shown by a resource which has replaced an original resource in the data broadcast reception apparatus, without changing the contents of TOC information.

Though the module which replaces the original module is designated by the replacement resource name in the above data broadcast control information, instead a replacement module ID may be included in the data broadcast control information to identify the module.

(Operation)

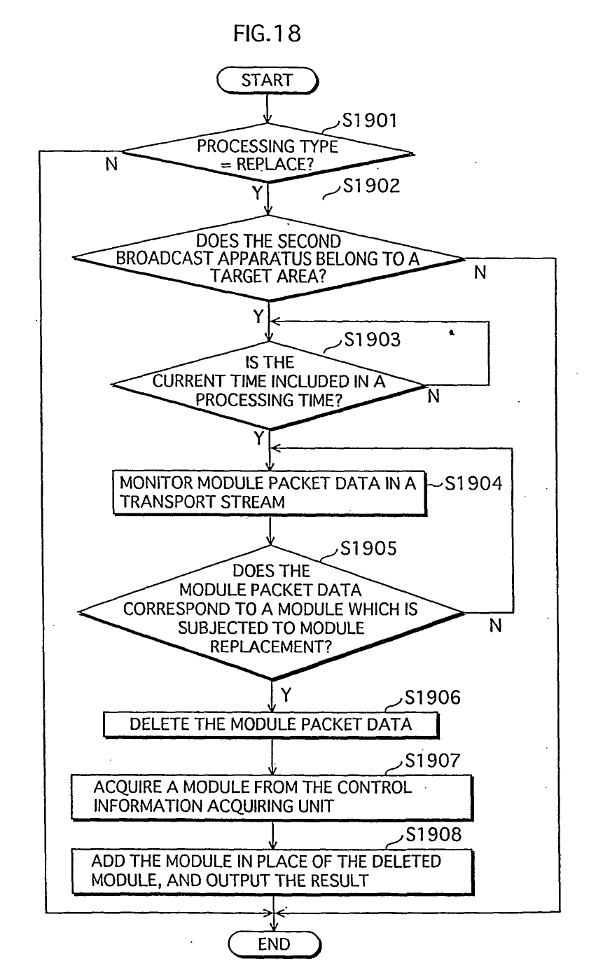

An operation of the module replacement processing performed by the data processing unit 803 is explained below. FIG. 18 is a flowchart showing the operation of the module replacement processing.

Upon receiving data broadcast control information from the control information acquiring unit 802, the data processing unit 803 judges whether a processing type shown by the data broadcast control information is “replace” (S1901). If so (S1901:Y), the data processing unit 803 judges whether a target area ID shown by the data broadcast control information matches the area ID held in the data processing unit 803, to judge whether the second broadcast program 800 belongs to a target area (S1902).

If they match (S1902:Y), the data processing unit 803 judges whether the current time is included in a processing time shown by the data broadcast control information (S1903).

If so (S1903:Y), the data processing unit 803 monitors module packet data included in a transport stream received from the receiving unit 205 (S1904). The data processing unit 803 judges whether the module packet data corresponds to a module which is to be replaced, by comparing a PID and module ID of the module packet data with a processing target PID and processing target module ID shown by the data broadcast control information (S1905).

If so (S1905:Y), the data processing unit 803 deletes the module packet data (S1906). The data processing unit 803 then acquires a module which is made up of replacement resources identified by replacement resource names shown by the data broadcast control information, from the control information acquiring unit 802 (S1907). The data processing unit 803 divides the acquired module into module packet data, and outputs it to the broadcasting unit 206. Thus, the module in the transport stream is replaced by the different module (S1908).

If the judgement is negative in step S1901 (S1901:N) or S1902 (S1902:N), the data processing unit 803 outputs the transport stream to the broadcasting unit 206 as it is, without performing the replacement processing.

If the judgement is negative in step S1903 (S1903:N), the data processing unit 803 waits until the processing time has come.

If the judgement is negative in step S1905 (S1905:N), the data processing unit 803 returns to step S1904.

In the above operation, the data processing unit 803 may replace an event message instead of a module. In this case, the data broadcast control information includes a processing target event message ID for identifying an event message to be replaced by a replacement event message, a replacement event message ID for identifying the replacement event message, and the replacement event message to which the replacement event message ID is attached. Event message replacement processing is the same as the above module replacement processing shown in FIG. 18 if “the module” in the description of FIG. 18 is changed to “the event message”, so that its explanation has been omitted.

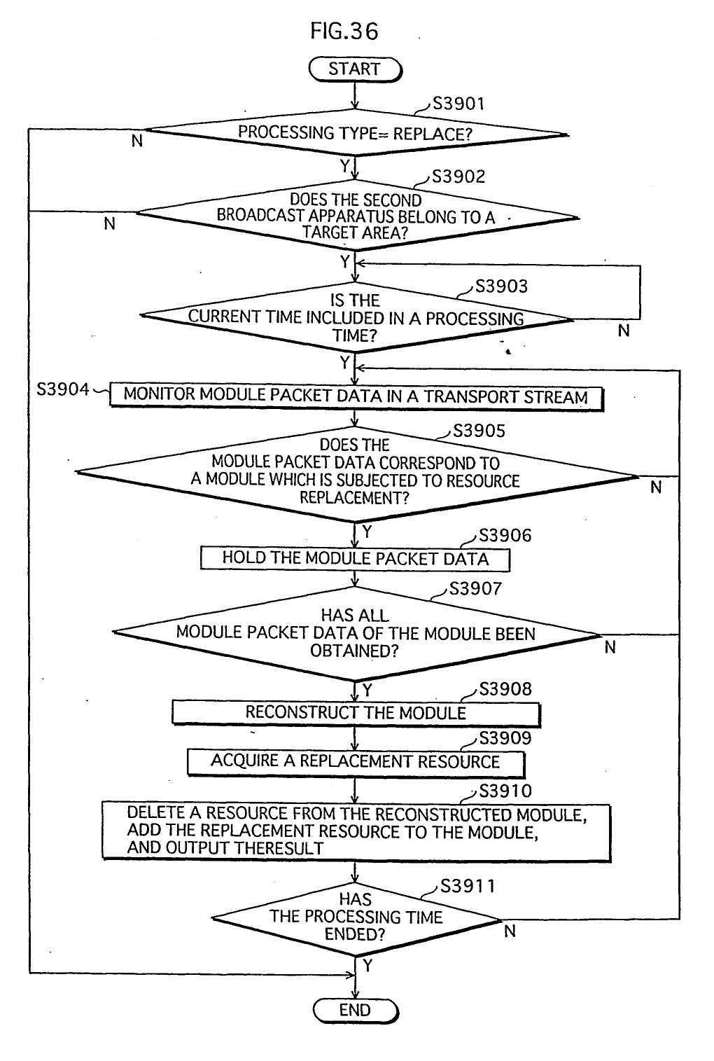

An operation of the resource replacement processing performed by the data processing unit 803 is explained next. FIG. 36 is a flowchart showing the operation of the resource replacement processing.

Steps S3901-S3908 and S3911 are similar to steps S3001-S3008 and S3011 of the resource replacement processing shown in FIG. 34, so that their explanation has been omitted.

The data processing unit 803 acquires a replacement resource identified by a replacement resource name shown by data broadcast control information, from the control information acquiring unit 802 (S3909). The data processing unit 803 deletes a resource identified by a processing target resource name from a reconstructed module, and adds the replacement resource to the module. The data processing unit 803 divides the module into module packet data, and outputs the result to the broadcasting unit 206 (S3910).

Fifth Embodiment

In the second embodiment, the second broadcast apparatus 400 stores a module, resource, or event message which is used for addition. In the fifth embodiment, the first broadcast apparatus sends a module, resource, or event message used for addition, to the second broadcast apparatus together with addition control information.

(Construction)

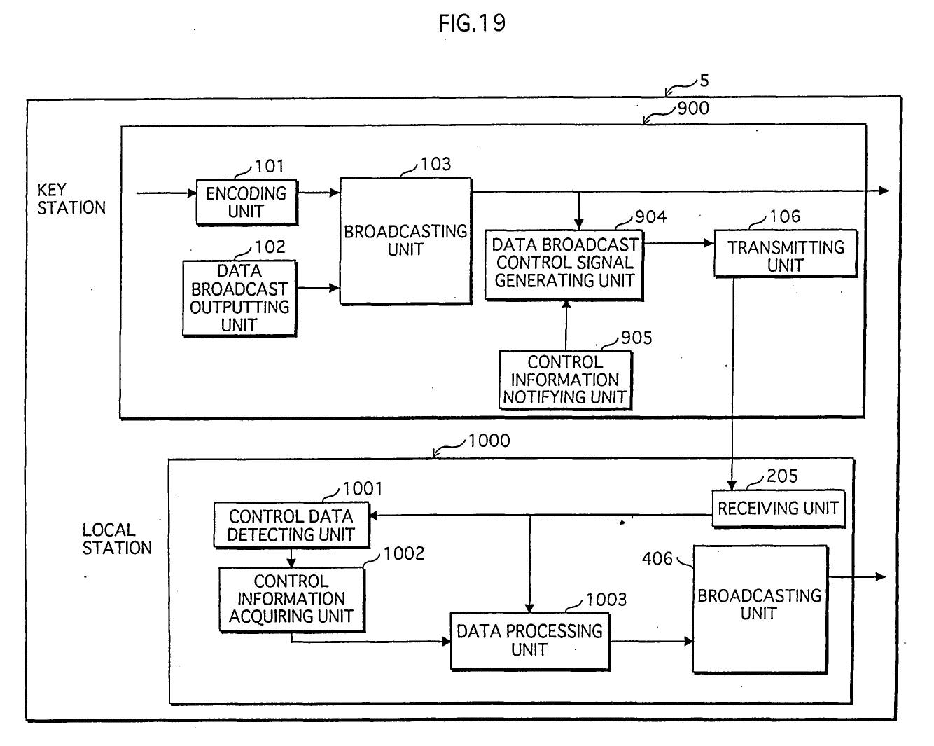

FIG. 19 shows a construction of a main part of a data broadcast program control system 5 to which the fifth embodiment of the present invention relates. The data broadcast program control system 5 is roughly made up of a first broadcast apparatus 900 and a second broadcast apparatus 1000. Here, the number of first broadcast apparatuses 900 may not be limited to one. Likewise, the number of second broadcast apparatuses 1000 may not be limited to one.

The first broadcast apparatus 900 includes the encoding unit 101, the data broadcast outputting unit 102, the broadcasting unit 103, a data broadcast control signal generating unit 904, a control information notifying unit 905, and the transmitting unit 106. Construction elements which are the same as those in the first broadcast apparatus 300 in the second embodiment shown in FIG. 8 are given the same reference numerals, and the following description focuses on the differences with the second embodiment.

The control information notifying unit 905 receives input of addition control information and addition data from an operator. The control information notifying unit 905 outputs the addition control information and the addition data to the data broadcast control signal generating unit 904.

Here, the addition data may be included in the addition control information.

The addition control information has the same contents as the addition control information used in the second embodiment, and further has information showing an addition data name.

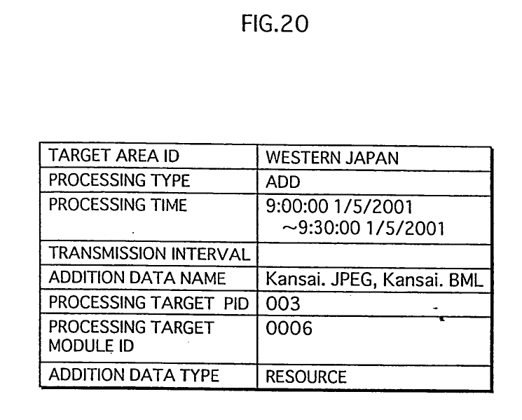

FIG. 20 shows an example of such addition control information.

In the drawing, the addition data name is an identifier for identifying the addition data. This identifier is attached to the addition data.

If the addition data is a module, names of all resources which constitute the module are designated as the addition data name. As an alternative, the addition data name may be undesignated, with the module being identified by the processing target PID and the processing target module ID. If the addition data is a resource, a name of the resource is designated as the addition data name. If the addition data is an event message, an identifier for identifying the event message is designated as the addition data name.

While the addition control information and the addition data are input by the operator in this example, the addition control information and the addition data may be stored in a memory beforehand, so that the control information notifying unit 905 reads the addition control information and the addition data from the memory and outputs them to the data broadcast control signal generating unit 904 at a predetermined time.

The data broadcast control signal generating unit 904 divides the addition control information and addition data received from the control information notifying unit 905, into control packet data. The data broadcast control signal generating unit 904 attaches a predetermined PID to the control packet data, multiplexes the control packet data in a transport stream received from the broadcasting unit 103, and outputs the transport stream to the transmitting unit 106.

The second broadcast apparatus 100 includes a control data detecting unit 1001, a control information acquiring unit 1002, a data processing unit 1003, the receiving unit 205, and the broadcasting unit 406.

Construction elements which are the same as those in the second broadcast apparatus 400 in the second embodiment shown in FIG. 8 are given the same reference numerals, and the following description focuses on the differences with the second embodiment.

The control data detecting unit 1001 detects the control packet data from the transport stream received from the receiving unit 205, based on the predetermined PID. The control data detecting unit 1001 outputs the control packet data to the control information acquiring unit 1002.

The control information acquiring unit 1002 decodes the control packet data received from the control data detecting unit 1001, to acquire the addition control information and the addition data. The control information acquiring unit 1002 outputs them to the data processing unit 1003.

The data processing unit 1003 adds the addition data according to the addition control information, in the following manner.

When the processing time shown by the addition control information received from the control information acquiring unit 1002 has come, the data processing unit 1003 specifies the addition data based on the addition data name shown by the addition control information, and acquires the addition data from the control information acquiring unit 1002. The data processing unit 1003 divides the addition data into module packet data, and outputs the result to the broadcasting unit 406 according to the transmission interval shown by the addition control information.

Here, the processing target PID, processing target module ID, and addition data name shown by the addition control information are attached to the module packet data which is output to the broadcasting unit 406.

The other functions of the data processing unit 1003 are the same as those of the data processing unit 403 in the second embodiment, so that their explanation has been omitted.

(Operation)

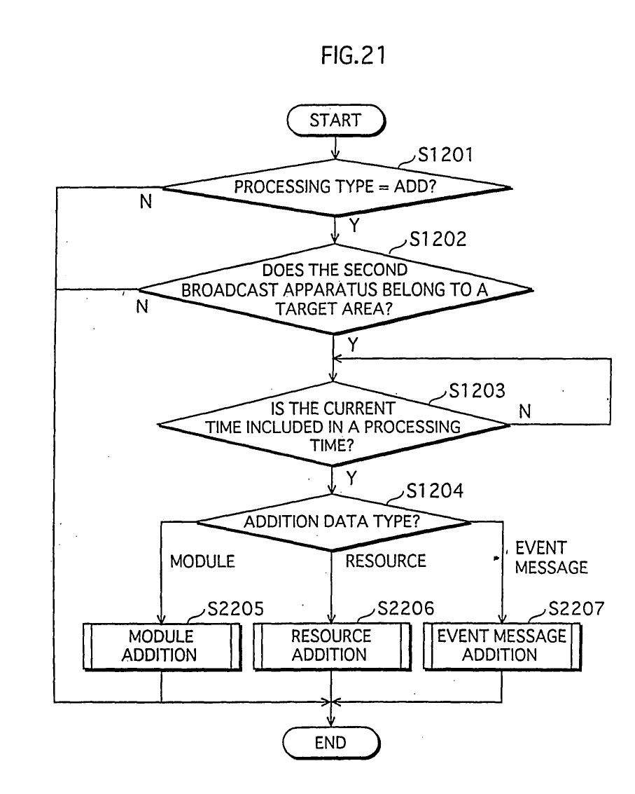

An operation of addition data addition processing performed by the data processing unit 1003 is described below. FIG. 21 is a flowchart showing the operation of the addition data addition processing. This operation differs from the operation shown in FIG. 11 only in the contents of module addition processing (S2205), resource addition processing (S2206), and event message addition processing (S2207). Accordingly, an explanation on the flowchart of FIG. 21 has been omitted here, and the following explains each of these processing.

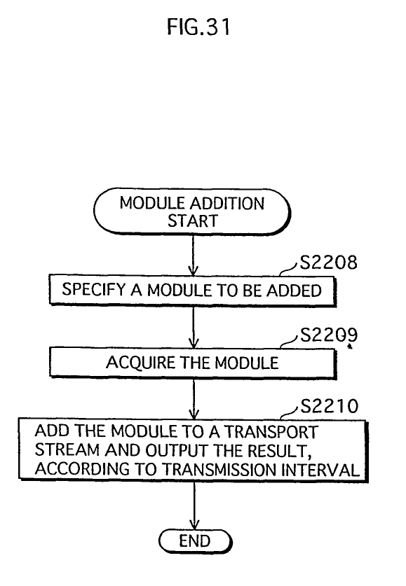

The module addition processing (S2205) performed by the data processing unit 1003 is explained first. FIG. 31 is a flowchart showing the module addition processing.

The data processing unit 1003 specifies a module (i.e. all resources constituting the module) to be added, based on an addition data name shown by addition control information received from the control information acquiring unit 1002 (S2208). The data processing unit 1003 acquires the module from the control information acquiring unit 1002 (S2209). The data processing unit 1003 divides the module into module packet data, and attaches a processing target PID, processing target module ID, and addition data name (the name of each resource in this example) shown by the addition control information, to each divided set of module packet data. The data processing unit 1003 adds the resulting module packet data to a transport stream received from the receiving unit 205 and outputs the transport stream to the broadcasting unit 406, according to a transmission interval shown by the addition control information (S2210).

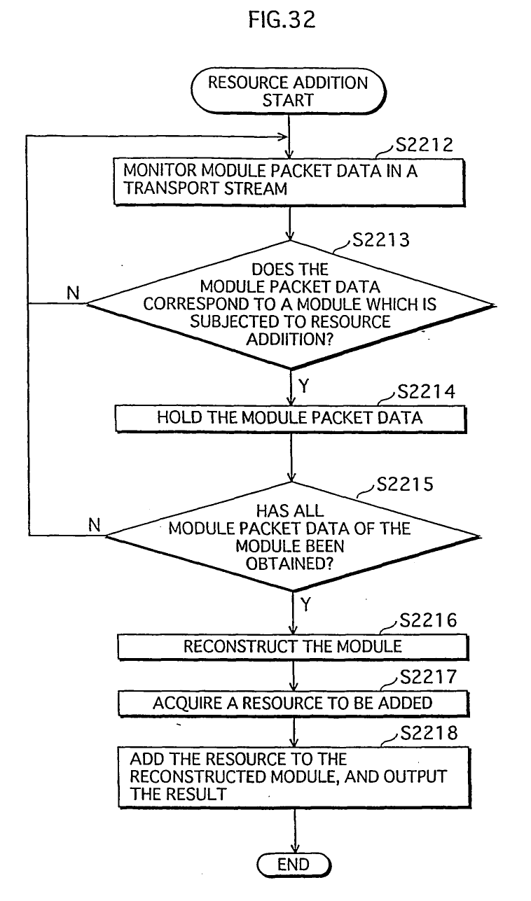

The resource addition processing (S2206) performed by the data processing unit 1003 is explained next. FIG. 32 is a flowchart showing the resource addition processing.

The data processing unit 1003 monitors module packet data received from the receiving unit 205 (S2212). The data processing unit 1003 judges whether the module packet data corresponds to a module to which a resource is to be added, by comparing a PID and module ID of the module packet data with a processing target PID and processing target module ID shown by addition control information received from the control information acquiring unit 1002 (S2213). If so (S2213:Y), the data processing unit 1003 holds the module packet data (S2214), and judges whether all module packet data that constitutes the module has been obtained (S2215).

If so (S2215:Y), the data processing unit 1003 reconstructs the module from the obtained module packet data (S2216). The data processing unit 1003 then acquires a resource identified by an addition data name shown by the addition control information, from the control information acquiring unit 1002 (S2217). The data processing unit 1003 adds the resource to the reconstructed module, and divides the module into module packet data. The data processing unit 1003 outputs the result to the broadcasting unit 406 (S2218).

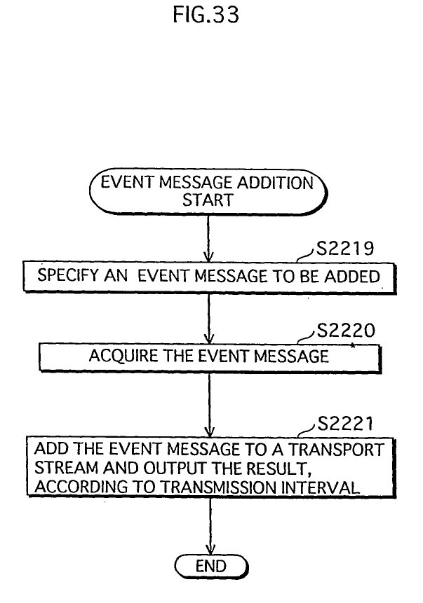

The event message addition processing (S2207) performed by the data processing unit 1003 is explained next. FIG. 33 is a flowchart showing the event message addition processing.

The data processing unit 1003 specifies an event message identified by an addition data name shown by addition control information received from the control information acquiring unit 1002 (S2219). The data processing unit 1003 acquires the event message from the control information acquiring unit 1002 (S2220). The data processing unit 1003 adds the event message to a transport stream received from the receiving unit 205 and outputs it to the broadcasting unit 406, according to a transmission interval shown by the addition control information (S2221).

Modifications

Though the data broadcast program control system of the present invention has been described based on the first to fifth embodiments, it should be obvious that the invention is not limited to such. The following are example modifications to the embodiments.

(1) The first broadcast apparatus may be modified as follows.

### First Modification Example

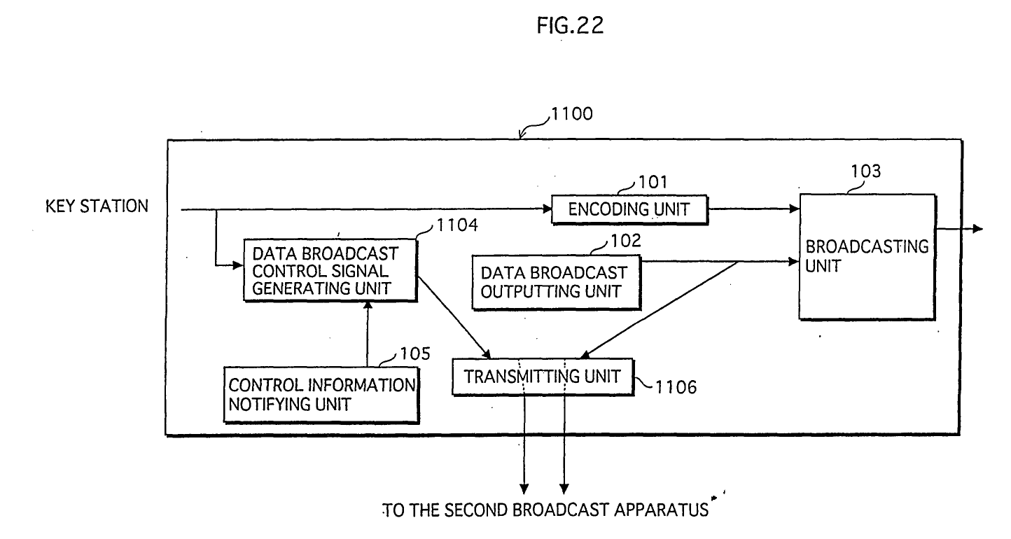

FIG. 22 is a functional block diagram showing a construction of a first broadcast apparatus 1100. The first broadcast apparatus 1100 includes the encoding unit 101, the data broadcast outputting unit 102, the broadcasting unit 103, a data broadcast control signal generating unit 1104, the control information notifying unit 105, and a transmitting unit 1106.

Construction elements which are the same as those in the first broadcast apparatus 100 in the first embodiment shown in FIG. 1 are given the same reference numerals, and the following explanation focuses on the differences with the first embodiment.

The data broadcast control signal generating unit 1104 superimposes data broadcast control information received from the control information notifying unit 105 onto a video signal which is input in the first broadcast apparatus 1100, in a specific horizontal scan period of the video signal. Having done so, the data broadcast control signal generating unit 1104 outputs the video signal to the transmitting unit 1106.

The transmitting unit 1106 transmits data broadcast data received from the data broadcast outputting unit 102 and the video signal received from the data broadcast control signal generating unit 1104 on which the data broadcast control information has been superimposed, separately to the second broadcast apparatus.

It should be noted that the control information notifying unit 105 may instead be the control information notifying unit 305, the control information notifying unit 705, or the control information notifying unit 905.

This modification example can be applied to any of the first to fifth embodiments.

### Second Modification Example

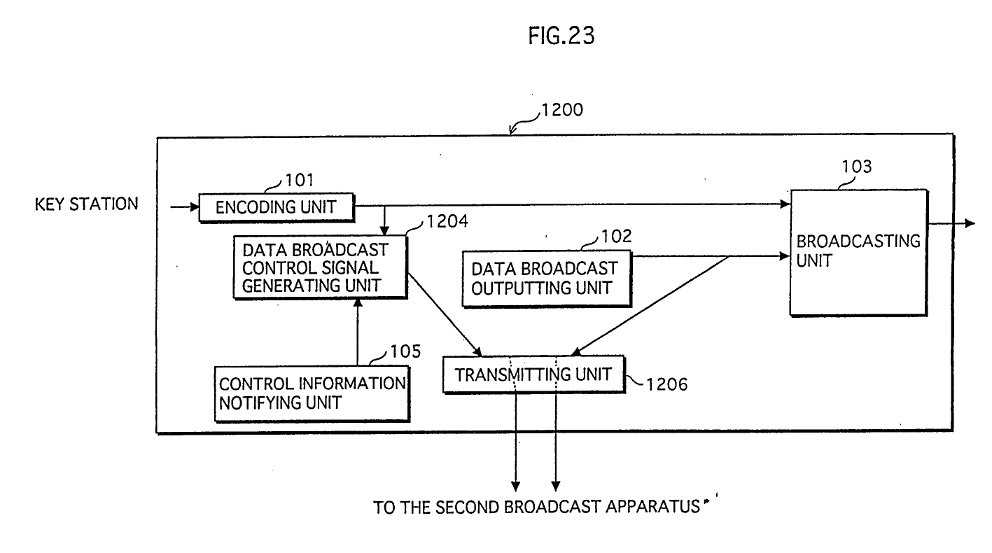

FIG. 23 is a functional block diagram showing a construction of a first broadcast apparatus 1200. The first broadcast apparatus 1200 includes the encoding unit 101, the data broadcast outputting unit 102, the broadcasting unit 103, a data broadcast control signal generating unit 1204, the control information notifying unit 105, and a transmitting unit 1206.

The data broadcast control signal generating unit 1204 multiplexes data broadcast control information received from the control information notifying unit 105, with video and audio data received from the encoding unit 101. The data broadcast control signal generating unit 1204 outputs the result to the transmitting unit 1206.

Here, the data broadcast control signal generating unit 1204 may multiplex the data broadcast control information in the form of PES or section in MPEG2.

The transmitting unit 1206 transmits data broadcast data received from the data broadcast outputting unit 102 and the video and audio data received from the data broadcast control signal generating unit 1204 in which the data broadcast control information has been multiplexed, separately to the second broadcast apparatus.

Alternatively, the transmitting unit 1206 may multiplex the data broadcast data with the video and audio data, and transmit the result.

It should be noted that the control information notifying unit 105 may instead be the control information notifying unit 305, the control information notifying unit 705, or the control information notifying unit 905.

This modification example can be applied to any of the first to fifth embodiments.

### Third Modification Example

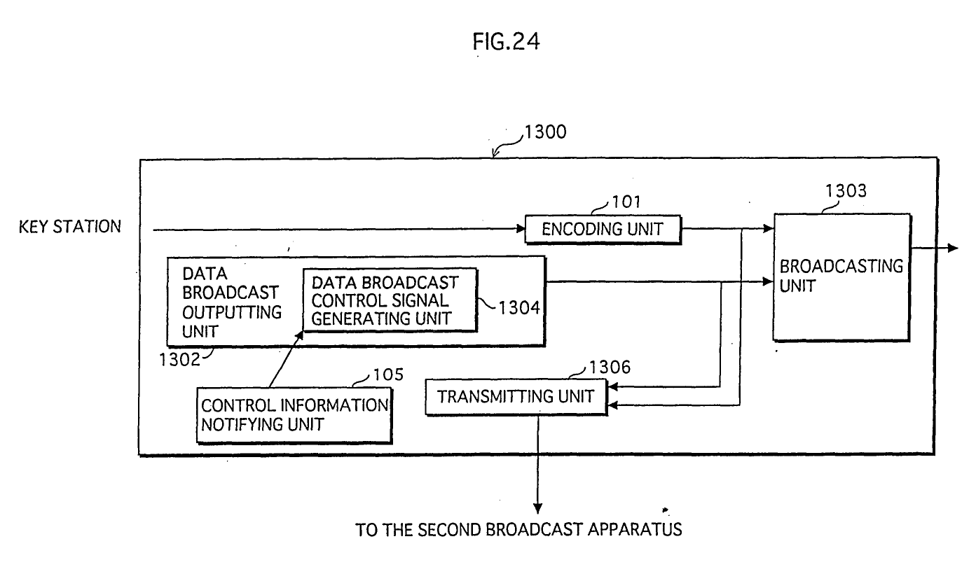

FIG. 24 is a functional block diagram showing a construction of a first broadcast apparatus 1300. The first broadcast apparatus 1300 includes the encoding unit 101, a data broadcast outputting unit 1302, a broadcasting unit 1303, the control information notifying unit 105, and a transmitting unit 1306.

The data broadcast outputting unit 1302 includes a data broadcast control signal generating unit 1304. The data broadcast control signal generating unit 1304 includes data broadcast control information received from the control information notifying unit 105, into data broadcast data. The data broadcast outputting unit 1302 outputs the data broadcast data that includes the data broadcast control information, according to a DSM-CC data carousel transmission method.

Here, the data broadcast control information may be written in a DII message (e.g. in a private data area of the DII message).

Also, the data broadcast control information may be written in a DDB message in the form of module or resource.

The broadcasting unit 1303 multiplexes video and audio data received from the encoding unit 101, with the data broadcast data including the data broadcast control information received from the data broadcast outputting unit 1302. The broadcasting unit 1303 outputs the result as a transport stream.

Here, the video and audio data and the data broadcast data do not need to be multiplexed. Instead, they may be output separately.

The transmitting unit 1306 multiplexes the video and audio data received from the encoding unit 101, with the data broadcast data including the data broadcast control information received from the data broadcast outputting unit 1302. The transmitting unit 1306 transmits the result to the second broadcast apparatus as a transport stream.

It should be noted that the control information notifying unit 105 may instead be the control information notifying unit 305, the control information notifying unit 705, or the control information notifying unit 905.

This modification example can be applied to any of the first to fifth embodiments.

### Fourth Modification Example

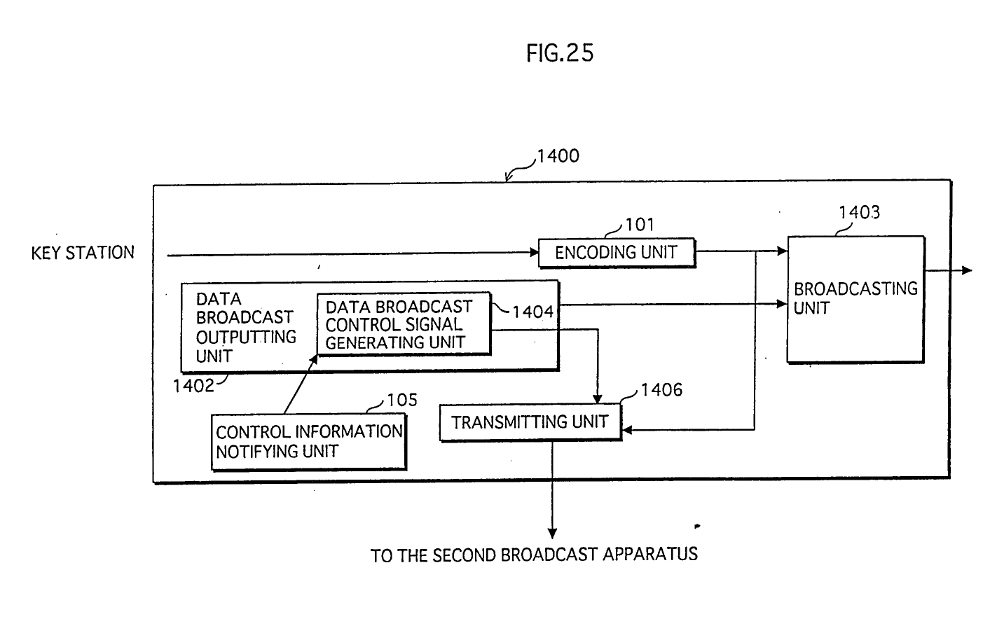

FIG. 25 is a functional block diagram showing a construction of a first broadcast apparatus 1400. The first broadcast apparatus 1400 includes the encoding unit 101, a data broadcast outputting unit 1402, a broadcasting unit 1403, the control information notifying unit 105, and a transmitting unit 1406.

The data broadcast outputting unit 1402 includes a data broadcast control signal generating unit 1404. The data broadcast control signal generating unit 1404 includes data broadcast control information received from the control information notifying unit 105, into data broadcast data. The data broadcast control signal generating unit 1404 outputs the result to the transmitting unit 1406.

Meanwhile, the data broadcast outputting unit 1402 outputs the data broadcast data that does not include the data broadcast control information, to the broadcasting unit 1403 according to a DSM-CC data carousel transmission method.

Note here that the data broadcast control information may be written in a DII message (e.g. in a private data area of the DII message).

The broadcasting unit 1403 multiplexes video and audio data received from the encoding unit 101, with the data broadcast data received from the data broadcast outputting unit 1402 which does not include the data broadcast control information. The broadcasting unit 1403 outputs the result as a transport stream.

Here, the video and audio data and the data broadcast data do not need to be multiplexed. Instead, they may be output separately.

The transmitting unit 1406 multiplexes the video and audio data received from the encoding unit 101, with the data broadcast data including the data broadcast control information received from the data broadcast control signal generating unit 1404. The transmitting unit 1406 transmits the result to the second broadcast apparatus as a transport stream.

It should be noted that the control information notifying unit 105 may instead be the control information notifying unit 305, the control information notifying unit 705, or the control information notifying unit 905.

This modification example can be applied to any of the first to fifth embodiments.

### Fifth Modification Example

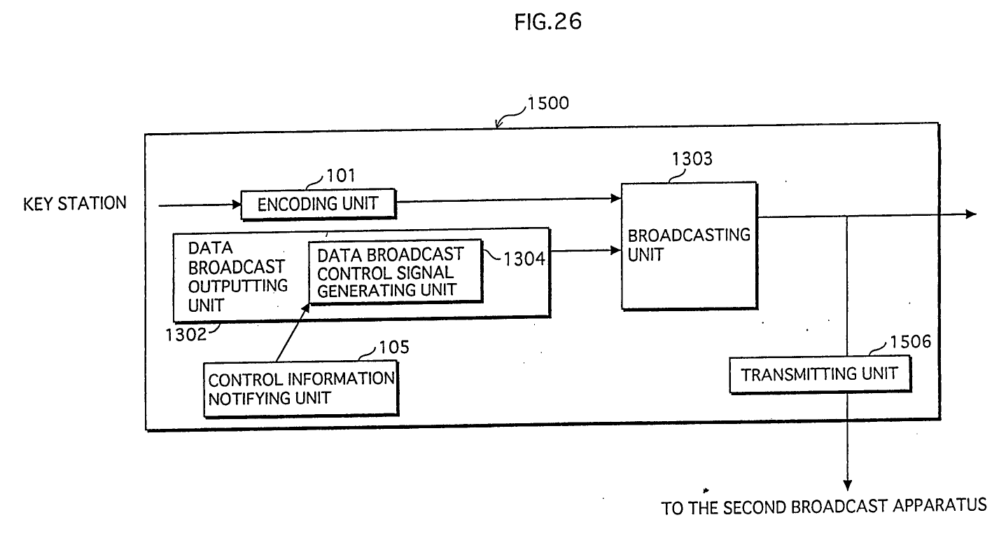

FIG. 26 is a functional block diagram showing a construction of a first broadcast apparatus 1500. The first broadcast apparatus 1500 includes the encoding unit 101, the data broadcast outputting unit 1302, the broadcasting unit 1303, the control information notifying unit 105, and a transmitting unit 1506.

Construction elements which are the same as those in the first broadcast apparatus 1300 shown in FIG. 24 are given the same reference numerals, and the following explanation focuses on the differences with the first broadcast apparatus 1300.

The transmitting unit 1506 transmits a transport stream received from the broadcasting unit 1303, to the second broadcast apparatus.

It should be noted that the control information notifying unit 105 may instead be the control information notifying unit 305, the control information notifying unit 705, or the control information notifying unit 905.

This modification example can be applied to any of the first to fifth embodiments.

### Sixth Modification Example

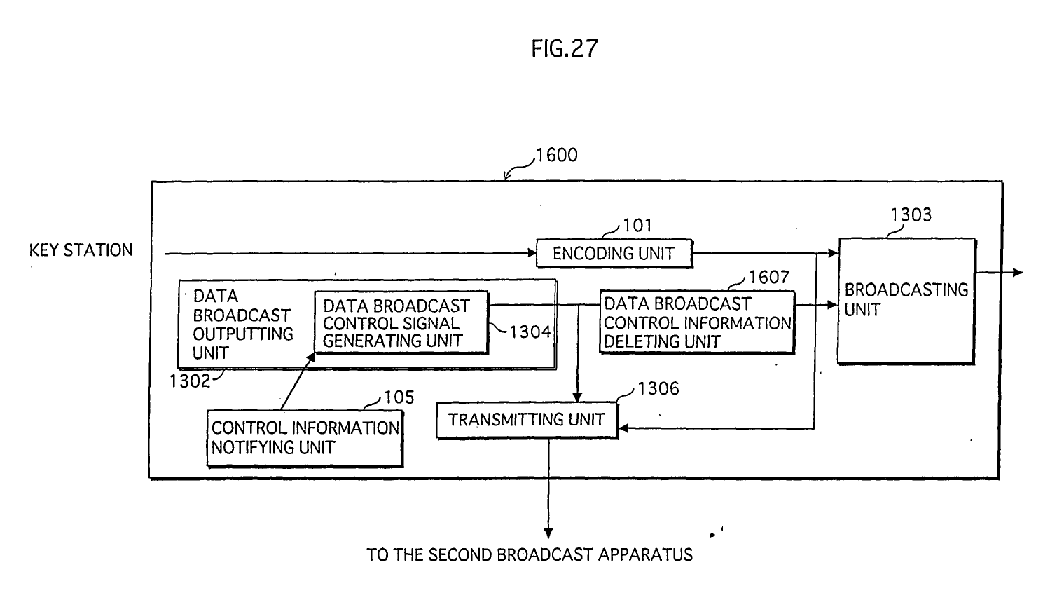

FIG. 27 is a functional block diagram showing a construction of a first broadcast apparatus 1600. The first broadcast apparatus 1600 includes the encoding unit 101, the data broadcast outputting unit 1302, the broadcasting unit 1303, the control information notifying unit 105, the transmitting unit 1306, and a data broadcast control information deleting unit 1607.

Construction elements which are the same as those in the first broadcast apparatus 1300 shown in FIG. 24 are given the same reference numerals, and the following explanation focuses on the differences with the first broadcast apparatus 1300.

In addition to the construction elements of the first broadcast apparatus 1300, the first broadcast apparatus 1600 newly includes the data broadcast control information deleting unit 1607.

The data broadcast control information deleting unit 1607 deletes data broadcast control information from data broadcast data received from the data broadcast outputting unit 1302, and outputs the result to the broadcasting unit 1303.

The broadcasting unit 1303 multiplexes video and audio data received from the encoding unit 101, with the data broadcast data received from the data broadcast outputting unit 1302 from which the data broadcast control information has been deleted. The broadcasting unit 1303 outputs the result as a transport stream.

It should be noted that the control information notifying unit 105 may instead be the control information notifying unit 305, the control information notifying unit 705, or the control information notifying unit 905.

This modification example can be applied to any of the first to fifth embodiments.

### Seventh Modification Example

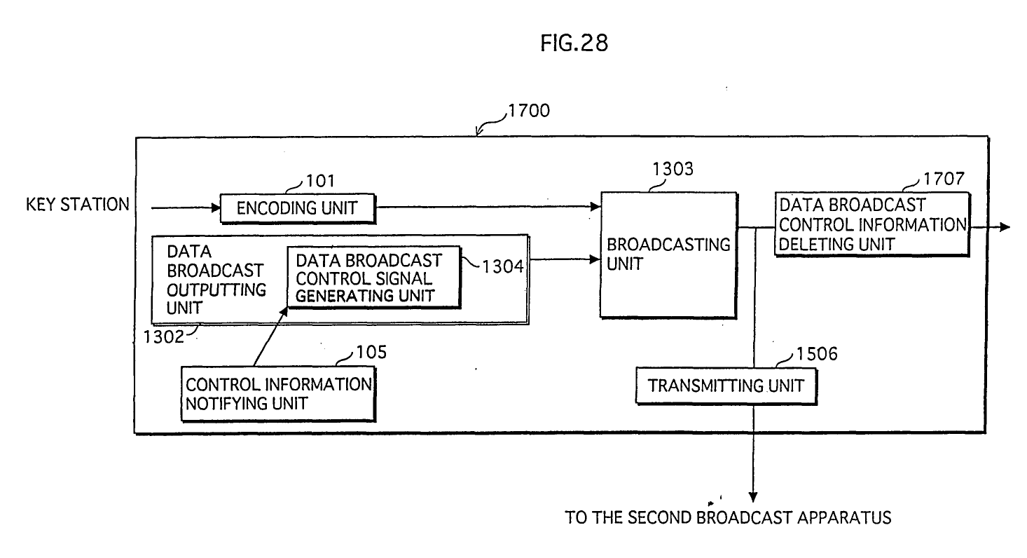

FIG. 28 is a functional block diagram showing a construction of a first broadcast apparatus 1700. The first broadcast apparatus 1700 includes the encoding unit 101, the data broadcast outputting unit 1302, the broadcasting unit 1303, the control information notifying unit 105, the transmitting unit 1506, and a data broadcast control information deleting unit 1707.

Construction elements which are the same as those in the first broadcast apparatus 1500 shown in FIG. 26 are given the same reference numerals, and the following explanation focuses on the differences with the first broadcast apparatus 1500.

In addition to the construction elements of the first broadcast apparatus 1500, the first broadcast apparatus 1700 newly includes the data broadcast control information deleting unit 1707.

The data broadcast control information deleting unit 1707 deletes data broadcast control information from data broadcast data received from the broadcasting unit 1303, and outputs the result.

It should be noted that the control information notifying unit 105 may instead be the control information notifying unit 305, the control information notifying unit 705, or the control information notifying unit 905.

This modification example can be applied to any of the first to fifth embodiments.

(2) The first to fifth embodiments describe the case where a processing time is designated as a time period. However, a processing time may instead be designated as a timing, such as “two seconds later” or “three seconds later”.

Also, a processing time may be designated using only a processing start time, or using both a processing start time and a processing end time.

Also, processing does not need to be continuously performed during a processing time. For example, processing may be completed after having been performed a specified number of times.

(3) The contents of data broadcast control information are not limited to those shown in the first to fifth embodiments. For example, the data broadcast control information may include a script describing a procedure which is to be carried out by the second broadcast apparatus.

By transmitting such a script to the second broadcast apparatus through the data broadcast control information, the first broadcast apparatus can control the data processing unit in the second broadcast apparatus to perform processing according to the procedure (e.g. prohibiting transmission of received data broadcast data, changing a frequency band, or filtering data of a designated PID) described in the script.

(4) In the first to fifth embodiments, the first broadcast apparatus may transmit data broadcast control information not once but a plurality of number of times.

(5) The first to fifth embodiments describe the case where data broadcast data and data broadcast control information are transmitted according to a transport stream transmission method. However, the transmission method is not limited to such.

For instance, the data broadcast data and the data broadcast control information may be transmitted according to SDI (Serial Digital Interface) which is standardized by the SMPTE (Society of Motion Picture and Television Engineers) 295M standard for digital video and audio. In such a case, the data broadcast data and the data broadcast control information can be included in the ancillary data space (where auxiliary data other than video data is inserted) of an SDI video signal.

As an alternative, the data broadcast data and the data broadcast control information may be transmitted according to an IP (Internet Protocol) transmission method.

(6) The second and fifth embodiments describe the case where data is added to data broadcast data which is transmitted from the first broadcast apparatus. This can be modified as follows. Without receiving data broadcast data from the first broadcast apparatus, the data processing unit in the second broadcast apparatus performs the addition processing shown in FIG. 11 or 21 based on data broadcast control information received from the first broadcast apparatus, and broadcasts data obtained as a result of the addition processing.

(7) The first to fifth embodiments describe the case where the second broadcast apparatus is identified by its area ID. This can be modified as follows. The second broadcast apparatus is given a second broadcast apparatus ID for identifying the second broadcast apparatus. This being so, data broadcast control information includes a second broadcast apparatus ID. In this way, when there are a plurality of second broadcast apparatuses, the first broadcast apparatus can designate different processing for each second broadcast apparatus, using a corresponding second broadcast apparatus ID in the data broadcast control information.

Also, even if the second broadcast apparatus is instructed by data broadcast control information to execute processing, the second broadcast apparatus may ignore that instruction.

(8) The first embodiment describes the case where a module or a resource is replaced with another module or resource, but an event message may be replaced with another event message. In this case, data broadcast control information includes a processing target event message ID for identifying an event message which is to be replaced, instead of the processing target resource name. Also, the resource data storing unit 204 stores an event message which is to replace the former event message, in association with the processing target event message ID. Such event message replacement processing is the same as the module replacement processing shown in FIG. 7 if “the module” in the description of FIG. 7 is changed to “the event message”, so that its explanation has been omitted.

### INDUSTRIAL APPLICABILITY

The data broadcast program control system of the present invention can be used for an apparatus that changes the constitution of a data broadcast program which is transmitted from a key station to each local station.

1. A data broadcast program control system including a transmission apparatus that repeatedly transmits a plurality of data elements which constitute a data broadcast program, and a broadcast apparatus that receives and broadcasts the plurality of data elements, characterized in that
the transmission apparatus includes:
control information generating means for generating control information, the control information instructing the broadcast apparatus to perform change processing on a constitution of the data broadcast program; and
transmitting means for transmitting the control information to the broadcast apparatus, and
the broadcast apparatus includes:
receiving means for receiving the control information;
changing means for performing the change processing on the constitution of the data broadcast program according to the control information; and
broadcasting means for broadcasting the data broadcast program whose constitution has been changed.

2. The data broadcast program control system of claim 1,
wherein the control information includes data element information, type information, and time information, the data element information specifying a data element out of the plurality of data elements which is subjected to the change processing, the type information showing a type of the change processing, and the time information showing a time for performing the change processing,
the broadcast apparatus further includes:
storing means for storing a replacement data element that is associated with the data element information, the replacement data element being a data element which is to replace the data element specified by the data element information, and
the changing means includes:
type judging means for judging the type of the change processing shown by the type information;
deleting means for deleting, if the type of the change processing is replacement, the data element specified by the data element information from the plurality of data elements when the time shown by the time information has come; and
outputting means for reading the replacement data element associated with the data element information from the storing means, and outputting the read replacement data element and the plurality of data elements except the deleted data element.

3. The data broadcast program control system of claim 2 including a plurality of broadcast apparatuses,
wherein the control information further includes apparatus information specifying which of the plurality of broadcast apparatuses is to perform the change processing,
the changing means further includes:
apparatus judging means for judging whether the broadcast apparatus is specified by the apparatus information, and
the changing means performs the change processing, only if the broadcast apparatus is specified by the apparatus information.

4. The data broadcast program control system of claim 1,
wherein the control information includes data element information, type information, time information, and a replacement data element, the data element information specifying a data element out of the plurality of data elements which is subjected to the change processing, the type information showing a type of the change processing, the time information showing a time for performing the change processing, and the replacement data element being a data element which is to replace the data element specified by the data element information, and
the changing means includes:
type judging means for judging the type of the change processing shown by the type information;
deleting means for deleting, if the type of the change processing is replacement, the data element specified by the data element information from the plurality of data elements when the time shown by the time information has come;
acquiring means for acquiring the replacement data element included in the control information; and
outputting means for outputting the acquired replacement data element and the plurality of data elements except the deleted data element.

5. The data broadcast program control system of claim 4 including a plurality of broadcast apparatuses,
wherein the control information further includes apparatus information specifying which of the plurality of broadcast apparatuses is to perform the change processing,
the changing means further includes:
apparatus judging means for judging whether the broadcast apparatus is specified by the apparatus information, and
the changing means performs the change processing, only if the broadcast apparatus is specified by the apparatus information.

6. The data broadcast program control system of claim 1,
wherein the control information includes type information and time information, the type information showing a type of the change processing, and the time information showing a time for performing the change processing,
the broadcast apparatus further includes:
storing means for storing an addition data element which is a data element to be added to the plurality of data elements, and
the changing means includes:
type judging means for judging the type of the change processing shown by the type information;
reading means for reading, if the type of the change processing is addition, the addition data element from the storing means when the time shown by the time information has come; and
outputting means for outputting the read addition data element and the plurality of data elements.

7. The data broadcast program control system of claim 6,
wherein the storing means stores one or more addition data elements which are each associated with a transmission time slot for transmitting the addition data element, and
the reading means reads an addition data element that is associated with a transmission time slot which includes the time shown by the time information.

8. The data broadcast program control system of claim 7 including a plurality of broadcast apparatuses,
wherein the control information further includes apparatus information specifying which of the plurality of broadcast apparatuses is to perform the change processing,
the changing means further includes:
apparatus judging means for judging whether the broadcast apparatus is specified by the apparatus information, and
the changing means performs the change processing, only if the broadcast apparatus is specified by the apparatus information.

9. The data broadcast program control system of claim 1,
wherein the control information includes type information, time information, and an addition data element, the type information showing a type of the change processing, the time information showing a time for performing the change processing, and the addition data element being a data element which is to be added to the plurality of data elements, and
the changing means includes:
type judging means for judging the type of the change processing shown by the type information;
acquiring means for acquiring, if the type of the change processing is addition, the addition data element included in the control information when the time shown by the time information has come; and
outputting means for outputting the acquired addition data element and the plurality of data elements.

10. The data broadcast program control system of claim 9, including a plurality of broadcast apparatuses,
wherein the control information further includes apparatus information specifying which of the plurality of broadcast apparatuses is to perform the change processing,
the changing means further includes:
apparatus judging means for judging whether the broadcast apparatus is specified by the apparatus information, and
the changing means performs the change processing, only if the broadcast apparatus is specified by the apparatus information.

11. The data broadcast program control system of claim 1,
wherein the plurality of data elements are a plurality of modules which each include a plurality of resources,
the control information includes module information, type information, and time information, the module information specifying a module out of the plurality of modules which is subjected to the change processing, the type information showing a type of the change processing, and the time information showing a time for performing the change processing,
the broadcast apparatus further includes:
storing means for storing an addition resource which is a resource to be added to the module specified by the module information, and
the changing means includes:
type judging means for judging the type of the change processing shown by the type information;
acquiring means for acquiring, if the type of the change processing is addition, the module specified by the module information when the time shown by the time information has come; and
outputting means for reading the addition resource from the storing means, adding the read addition resource to the acquired module, and outputting the plurality of modules in which the addition resource has been added to the module.

12. The data broadcast program control system of claim 1,
wherein the plurality of data elements are a plurality of modules which each include a plurality of resources,
the control information includes module information, type information, time information, and an addition resource, the module information specifying a module out of the plurality of modules which is subjected to the change processing, the type information showing a type of the change processing, the time information showing a time for performing the change processing, and the addition resource being a resource which is to be added to the module specified by the module information, and
the changing means includes:
type judging means for judging the type of the change processing shown by the type information;
acquiring means for acquiring, if the type of the change processing is addition, the module specified by the module information and the addition resource included in the control information when the time shown by the time information has come; and
outputting means for adding the acquired addition resource to the acquired module, and outputting the plurality of modules in which the addition resource has been added to the module.

13. The data broadcast program control system of claim 1,
wherein the control information includes data element information, type information, and time information, the data element information specifying a data element out of the plurality of data elements which is subjected to the change processing, the type information showing a type of the change processing, and the time information showing a time for performing the change processing, and
the changing means includes:
type judging means for judging the type of the change processing shown by the type information;
deleting means for deleting, if the type of the change processing is deletion, the data element specified by the data element information from the plurality of data elements when the time shown by the time information has come; and
outputting means for outputting the plurality of data elements except the deleted data element.

14. The data broadcast program control system of claim 13, including a plurality of broadcast apparatuses,
wherein the control information further includes apparatus information specifying which of the plurality of broadcast apparatuses is to perform the change processing,
the changing means further includes:
apparatus judging means for judging whether the broadcast apparatus is specified by the apparatus information, and
the changing means performs the change processing, only if the broadcast apparatus is specified by the apparatus information.

15. The data broadcast program control system of claim 1,
wherein the control information includes type information and time information, the type information showing a type of the change processing, and the time information showing a time for performing the change processing,
the broadcast apparatus further includes:
storing means for storing one or more addition event messages that are each associated with a transmission time slot for transmitting the addition event message, and
the changing means includes:
type judging means for judging the type of the change processing shown by the type information;
reading means for reading, if the type of the change processing is addition, an addition event message from the storing means when the time shown by the time information has come, the read addition event message being associated with a transmission time slot that includes the time shown by the time information; and
outputting means for outputting the read addition event message and the plurality of data elements.

16. The data broadcast program control system of claim 15 including a plurality of broadcast apparatuses,
wherein the control information further includes apparatus information specifying which of the plurality of broadcast apparatuses is to perform the change processing,
the changing means further includes:
apparatus judging means for judging whether the broadcast apparatus is specified by the apparatus information, and
the changing means performs the change processing, only if the broadcast apparatus is specified by the apparatus information.

17. The data broadcast program control system of claim 1,
wherein the control information includes a script that shows a procedure of the change processing, and
the changing means performs the change processing in accordance with the procedure shown by the script.

18. The data broadcast program control system of claim 17 including a plurality of broadcast apparatuses,
wherein the control information further includes apparatus information specifying which of the plurality of broadcast apparatuses is to perform the change processing,
the changing means further includes:
apparatus judging means for judging whether the broadcast apparatus is specified by the apparatus information, and
the changing means performs the change processing, only if the broadcast apparatus is specified by the apparatus information.

19. The data broadcast program control system of claim 1,
wherein the control information includes type information, time information, and an addition event message, the type information showing a type of the change processing, the time information showing a time for performing the change processing, and the addition event message being an event message which is to be added to the plurality of data elements, and
the changing means includes:
type judging means for judging the type of the change processing shown by the type information;
acquiring means for acquiring, if the type of the change processing is addition, the addition event message included in the control information when the time shown by the time information has come; and
outputting means for outputting the acquired addition event message and the plurality of data elements.

20. The data broadcast program control system of claim 19 including a plurality of broadcast apparatuses,
wherein the control information further includes apparatus information specifying which of the plurality of broadcast apparatuses is to perform the change processing,
the changing means further includes:
apparatus judging means for judging whether the broadcast apparatus is specified by the apparatus information, and
the changing means performs the change processing, only if the broadcast apparatus is specified by the apparatus information.

21. A transmission apparatus for repeatedly transmitting a plurality of data elements that constitute a data broadcast program, to a broadcast apparatus, characterized by including:
control information generating means for generating control information for instructing the broadcast apparatus to perform change processing on a constitution of the data broadcast program; and
transmitting means for transmitting the control information to the broadcast apparatus.

22. The transmission apparatus of claim 21, further including:
obtaining means for obtaining a transport stream in which video data, audio data, and the plurality of data elements have been multiplexed,
wherein the control information generating means multiplexes the control information in the obtained transport stream, and
the transmitting means transmits the transport stream in which the control information has been multiplexed, to the broadcast apparatus.

23. The transmission apparatus of claim 21, further including:
obtaining means for obtaining a video signal,
wherein the control information generating means superimposes the control information on the obtained video signal, and
the transmitting means transmits the video signal on which the control information has been superimposed, to the broadcast apparatus.

24. The transmission apparatus of claim 21, further including:
obtaining means for obtaining video and audio data,
wherein the control information generating means multiplexes the control information in the obtained video and audio data, and
the transmitting means transmits the video and audio data in which the control information has been multiplexed, to the broadcast apparatus.

25. The transmission apparatus of claim 21,
wherein the control information generating means describes the control information in a DII (Download Info Indication) message, and outputs the DII message and the plurality of data elements according to a DSM-CC (Digital Storage Media-Command and Control) data carousel transmission method, and
the transmitting means transmits the DII message and the plurality of data elements output from the control information generating means, to the broadcast apparatus.

26. The transmission apparatus of claim 21,
wherein the control information generating means describes the control information in a DDB (Download Data Block) message, and outputs the DDB message and the plurality of data elements according to a DSM-CC (Digital Storage Media-Command and Control) data carousel transmission method, and
the transmitting means transmits the DDB message and the plurality of data elements output from the control information generating means, to the broadcast apparatus.

27. A broadcast apparatus for receiving a plurality of data elements from a transmission apparatus and broadcasting the plurality of data elements, the transmission apparatus repeatedly transmitting the plurality of data elements that constitute a data broadcast program, characterized by including:
receiving means for receiving control information from the transmission apparatus, the control information instructing the broadcast apparatus to perform change processing on a constitution of the data broadcast program;
changing means for performing the change processing on the constitution of the data broadcast program according to the control information; and
broadcasting means for broadcasting the data broadcast program whose constitution has been changed.

28. The broadcast apparatus of claim 27,
wherein the control information includes data element information, type information, and time information, the data element information specifying a data element out of the plurality of data elements which is subjected to the change processing, the type information showing a type of the change processing, and the time information showing a time for performing the change processing,
the broadcast apparatus further includes:
storing means for storing a replacement data element that is associated with the data element information, the replacement data element being a data element which is to replace the data element specified by the data element information, and
the changing means includes:
type judging means for judging the type of the change processing shown by the type information;
deleting means for deleting, if the type of the change processing is replacement, the data element specified by the data element information from the plurality of data elements when the time shown by the time information has come; and
outputting means for reading the replacement data element associated with the data element information from the storing means, and outputting the read replacement data element and the plurality of data elements except the deleted data element.

29. The broadcast apparatus of claim 28,
wherein the control information further includes apparatus information specifying which of a plurality of broadcast apparatuses is to perform the change processing,
the changing means further includes:
apparatus judging means for judging whether the broadcast apparatus is specified by the apparatus information, and
the changing means performs the change processing, only if the broadcast apparatus is specified by the apparatus information.

30. The broadcast apparatus of claim 27,
wherein the control information includes data element information, type information, time information, and a replacement data element, the data element information specifying a data element out of the plurality of data elements which is subjected to the change processing, the type information showing a type of the change processing, the time information showing a time for performing the change processing, and the replacement data element being a data element which is to replace the data element specified by the data element information, and
the changing means includes:
type judging means for judging the type of the change processing shown by the type information;
deleting means for deleting, if the type of the change processing is replacement, the data element specified by the data element information from the plurality of data elements when the time shown by the time information has come;
acquiring means for acquiring the replacement data element included in the control information; and
outputting means for outputting the acquired replacement data element and the plurality of data elements except the deleted data element.

31. The broadcast apparatus of claim 30,
wherein the control information further includes apparatus information specifying which of a plurality of broadcast apparatuses is to perform the change processing,
the changing means further includes:
apparatus judging means for judging whether the broadcast apparatus is specified by the apparatus information, and
the changing means performs the change processing, only if the broadcast apparatus is specified by the apparatus information.

32. The broadcast apparatus of claim 27,
wherein the control information includes type information and time information, the type information showing a type of the change processing, and the time information showing a time for performing the change processing,
the broadcast apparatus further includes:
storing means for storing an addition data element which is a data element to be added to the plurality of data elements, and
the changing means includes:
type judging means for judging the type of the change processing shown by the type information;
reading means for reading, if the type of the change processing is addition, the addition data element from the storing means when the time shown by the time information has come; and
outputting means for outputting the read addition data element and the plurality of data elements.

33. The broadcast apparatus of claim 32,
wherein the storing means stores one or more addition data elements which are each associated with a transmission time slot for transmitting the addition data element, and
the reading means reads an addition data element that is associated with a transmission time slot which includes the time shown by the time information.

34. The broadcast apparatus of claim 33,
wherein the control information further includes apparatus information specifying which of a plurality of broadcast apparatuses is to perform the change processing,
the changing means further includes:
apparatus judging means for judging whether the broadcast apparatus is specified by the apparatus information, and
the changing means performs the change processing, only if the broadcast apparatus is specified by the apparatus information.

35. The broadcast apparatus of claim 27,
wherein the control information includes type information, time information, and an addition data element, the type information showing a type of the change processing, the time information showing a time for performing the change processing, and the addition data element being a data element which is to be added to the plurality of data elements, and
the changing means includes:
type judging means for judging the type of the change processing shown by the type information;
acquiring means for acquiring, if the type of the change processing is addition, the addition data element included in the control information when the time shown by the time information has come; and
outputting means for outputting the acquired addition data element and the plurality of data elements.

36. The broadcast apparatus of claim 35,
wherein the control information further includes apparatus information specifying which of a plurality of broadcast apparatuses is to perform the change processing,
the changing means further includes:
apparatus judging means for judging whether the broadcast apparatus is specified by the apparatus information, and
the changing means performs the change processing, only if the broadcast apparatus is specified by the apparatus information.

37. The broadcast apparatus of claim 27,
wherein the plurality of data elements are a plurality of modules which each include a plurality of resources,
the control information includes module information, type information, and time information, the module information specifying a module out of the plurality of modules which is subjected to the change processing, the type information showing a type of the change processing, and the time information showing a time for performing the change processing,
the broadcast apparatus further includes:
storing means for storing an addition resource which is a resource to be added to the module specified by the module information, and
the changing means includes:
type judging means for judging the type of the change processing shown by the type information;
acquiring means for acquiring, if the type of the change processing is addition, the module specified by the module information when the time shown by the time information has come; and
outputting means for reading the addition resource from the storing means, adding the read addition resource to the acquired module, and outputting the plurality of modules in which the addition resource has been added to the module.

38. The broadcast apparatus of claim 27,
wherein the plurality of data elements are a plurality of modules which each include a plurality of resources,
the control information includes module information, type information, time information, and an addition resource, the module information specifying a module out of the plurality of modules which is subjected to the change processing, the type information showing a type of the change processing, the time information showing a time for performing the change processing, and the addition resource being a resource which is to be added to the module specified by the module information, and
the changing means includes:
type judging means for judging the type of the change processing shown by the type information;
acquiring means for acquiring, if the type of the change processing is addition, the module specified by the module information and the addition resource included in the control information when the time shown by the time information has come; and
outputting means for adding the acquired addition resource to the acquired module, and outputting the plurality of modules in which the addition resource has been added to the module.

39. The broadcast apparatus of claim 27,
wherein the control information includes data element information, type information, and time information, the data element information specifying a data element out of the plurality of data elements which is subjected to the change processing, the type information showing a type of the change processing, and the time information showing a time for performing the change processing, and
the changing means includes:
type judging means for judging the type of the change processing shown by the type information;
deleting means for deleting, if the type of the change processing is deletion, the data element specified by the data element information from the plurality of data elements when the time shown by the time information has come; and
outputting means for outputting the plurality of data elements except the deleted data element.

40. The broadcast apparatus of claim 39,
wherein the control information further includes apparatus information specifying which of a plurality of broadcast apparatuses is to perform the change processing,
the changing means further includes:
apparatus judging means for judging whether the broadcast apparatus is specified by the apparatus information, and
the changing means performs the change processing, only if the broadcast apparatus is specified by the apparatus information.

41. The broadcast apparatus of claim 27,
wherein the control information includes type information and time information, the type information showing a type of the change processing, and the time information showing a time for performing the change processing,
the broadcast apparatus further includes:
storing means for storing one or more addition event messages that are each associated with a transmission time slot for transmitting the addition event message, and
the changing means includes:
type judging means for judging the type of the change processing shown by the type information;
reading means for reading, if the type of the change processing is addition, an addition event message from the storing means when the time shown by the time information has come, the read addition event message being associated with a transmission time slot that includes the time shown by the time information; and
outputting means for outputting the read addition event message and the plurality of data elements.

42. The broadcast apparatus of claim 41,
wherein the control information further includes apparatus information specifying which of a plurality of broadcast apparatuses is to perform the change processing,
the changing means further includes:
apparatus judging means for judging whether the broadcast apparatus is specified by the apparatus information, and
the changing means performs the change processing, only if the broadcast apparatus is specified by the apparatus information.

43. The broadcast apparatus of claim 27,
wherein the control information includes a script that shows a procedure of the change processing, and
the changing means performs the change processing in accordance with the procedure shown by the script.

44. The broadcast apparatus of claim 43,
wherein the control information further includes apparatus information specifying which of a plurality of broadcast apparatuses is to perform the change processing,
the changing means further includes:
apparatus judging means for judging whether the broadcast apparatus is specified by the apparatus information, and
the changing means performs the change processing, only if the broadcast apparatus is specified by the apparatus information.

45. The broadcast apparatus of claim 27,
wherein the control information includes type information, time information, and an addition event message, the type information showing a type of the change processing, the time information showing a time for performing the change processing, and the addition event message being an event message which is to be added to the plurality of data elements, and
the changing means includes:
type judging means for judging the type of the change processing shown by the type information;
acquiring means for acquiring, if the type of the change processing is addition, the addition event message included in the control information when the time shown by the time information has come; and
outputting means for outputting the acquired addition event message and the plurality of data elements.

46. The broadcast apparatus of claim 45,
wherein the control information further includes apparatus information specifying which of a plurality of broadcast apparatuses is to perform the change processing,
the changing means further includes:
apparatus judging means for judging whether the broadcast apparatus is specified by the apparatus information, and
the changing means performs the change processing, only if the broadcast apparatus is specified by the apparatus information.
